(19) United States
(12) Patent Application Publication
(10) Pub. No.: US 2026/0136401 A1
(43) Pub. Date: May 14, 2026

(54) METHODS FOR SMART SYNCHRONIZATION SIGNAL BLOCK (SSB) BEAM SELECTION

(71) Applicant: Apple Inc., Cupertino, CA (US)

(72) Inventors: Bilal Zafar, San Diego, CA (US); Galib A Mohiuddin, San Jose, CA (US); Wei Zhang, Santa Clara, CA (US); Alosious Pradeep Prabhakar, Singapore (SG); Mohammed Sadique, Auburn (AU)

(21) Appl. No.: 18/946,108

(22) Filed: Nov. 13, 2024

(51) Int. Cl. H04W 74/0833; H04W 52/36

(52) U.S. Cl. CPC H04W 74/0833; H04W 52/367

(57) ABSTRACT

Various aspects of the present disclosure relate to methods for smart synchronization signal block (SSB) beam selection to minimize Random Access Channel (RACH) delay. A user equipment (UE) selects one or more candidate SSB beams from available SSB beams by selecting SSBs with signal strength (e.g., reference signal received power (RSRP) or the like) within a threshold amount of a greatest signal strength of the available SSB beams. After selecting the one or more candidate SSB beams, a target SSB beam is selected from the one or more candidate SSB beams by selecting an SSB beam with a least amount of delay to an associated RACH occasion. Further, a RACH preamble is transmitted at the RACH occasion associated with the target SSB beam.

### FIELD

This disclosure relates to wireless communication networks including methods for synchronization signal block (SSB) beam selection.

### BACKGROUND

For certain wireless communication networks, User Equipments (UEs) employ Random Access Channel (RACH) processes to, among other things, establish initial connections to the wireless communication networks. Such wireless communication networks include Fourth Generation (4G) or Long Term Evolution (LTE) networks, Fifth Generation (5G) or New Radio (NR) networks, and so on. The RACH processes facilitate Uplink Synchronization between the networks and the UEs and further facilitates acquisition of IDs by the UEs for subsequent wireless communication. Types of RACH processes include contention-based RACH and contention-free RACH.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 illustrates a diagram of an example of a wireless communication network with smart Synchronization Signal Slock (SSB) beam selection.

FIG. 2 illustrates an example of smart SSB beam selection using an example mapping between Random Access Channel (RACH) occasions and SSB beams.

FIGS. 3A and 3B illustrate additional examples of smart SSB beam selection using an example mapping between RACH occasions and SSB beams.

FIG. 4 illustrates a flow diagram of an example of a method for smart SSB beam selection.

FIGS. 5A-5C illustrate flow diagrams of examples of setting a threshold amount for candidate SSB beam selection.

FIG. 6 illustrates a timing diagram of an example of a threshold amount for candidate SSB beam selection varying over time.

FIGS. 7A and 7B illustrate a flow diagram of an example of a method for smart SSB beam selection.

FIG. 8 illustrates a timing diagram of an example of a threshold amount for candidate SSB beam selection varying over time.

FIGS. 9A and 9B illustrate a flow diagram of an example of a method for smart SSB beam selection.

FIG. 10 illustrates a timing diagram of an example of a threshold amount for candidate SSB beam selection varying over time.

FIG. 11 illustrates a diagram of an example of half frame structure for use with smart SSB beam selection.

FIG. 12 illustrates a diagram of an example of RACH occasions within a RACH slot for use with smart SSB beam selection.

FIG. 13 illustrates a diagram of an example of an SSB burst for use with smart SSB beam selection.

FIG. 14A-14C illustrate examples of slot, RACH, and SSB configurations for use with smart SSB beam selection.

FIG. 15 illustrates an example of smart SSB beam selection using an example mapping between RACH occasions and SSB beams.

FIG. 16 illustrates an example table for determining an association period for use with smart SSB beam selection.

FIG. 17 illustrates a sequence diagram of an example RACH process using smart SSB beam selection.

FIG. 18 illustrates a flow diagram of an example method for smart SSB beam selection at a User Equipment (UE).

FIG. 19 illustrates a flow diagram of an example method for smart SSB beam selection at a UE.

FIG. 20 illustrates a flow diagram of an example method for smart SSB beam selection at a Radio Access Network (RAN) node.

FIG. 21 illustrates a diagram of an example of a wireless communication network with smart SSB beam selection.

FIG. 22 illustrates a diagram of an example of a device within a wireless communication network with smart SSB beam selection.

FIG. 23 illustrates a diagram of an example of baseband circuitry for a device within a wireless communication network with smart SSB beam selection.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

For some wireless communication networks, Synchronization Signal Block (SSB) beams are configured by the network and are each associated with a Random Access Channel (RACH) occasion. Further, during a contention-based RACH process, a User Equipment (UE) selects an SSB beam from the configured SSB beams and transmits a RACH preamble to the network at the RACH occasion associated with the selected SSB beam. Such wireless communication networks include Fourth Generation (4G) or Long Term Evolution (LTE) networks, Fifth Generation (5G) or New Radio (NR) networks, and so on.

Because associations between SSB beams and RACH occasions are known to both the network and the UE, transmission of the RACH preamble implicitly identifies the UE-selected SSB beam to the network. The network can map the RACH occasion on which the RACH preamble is received to the UE-selected SSB beam using the known associations between SSB beams and RACH occasions. Once the network knows the UE-selected SSB beam, the network can beam form subsequent transmissions on the UE-selected SSB beam or on another SSB beam selected based on the UE-selected SSB beam.

SSB-beam selection by the UE is performed based on signal strength (e.g., Reference Signal Received Power (RSRP) or the like). The UE selects the SSB with the greatest signal strength and transmits the RACH preamble at the RACH occasion associated with the selected SSB beam. Because the UE must wait for the RACH occasion of the selected SSB beam to transmit the RACH preamble, there is a delay between when the UE is ready to transmit the RACH preamble and when the UE transmits the RACH preamble. Depending on which SSB beam the UE selects, the delay may be significant and, in the worst-case scenario, may be equal to an association period.

The association period generally corresponds to the minimum period with a sufficient number of RACH occasions to allow each configured SSB beam to be mapped to a RACH occasion at least once. In an example, the association period may be as described at section 8.1 in 3rd Generation Partnership Project (3GPP) Technical Specification (TS) 38.213 v17.11.0 and/or may have a maximum allowed value of 160 milliseconds (ms). For wireless communication networks with large numbers of SSB beams (e.g., 56 or more beams), it is common for the association period to be 160 ms (e.g., the maximum allowed value), whereby these networks may experience significant RACH delays. Such wireless networks generally include 5G Frequency Range 2(FR2 ) networks and the like.

In view of the foregoing, the present disclosure relates to methods for smart SSB beam selection to minimize RACH delay. In some aspects, the UE selects one or more candidate SSB beams from the configured SSB beams by selecting SSBs with signal strengths within a threshold amount of a greatest signal strength of the configured SSB beams. The threshold amount demarcates whether an SSB beam has a signal strength similar to the greatest signal strength and hence a probability of RACH success similar to a probability of RACH of the SSB beam with the greatest signal strength. A target SSB beam is then selected from the one or more candidate SSB beams by selecting an SSB beam with a least amount of delay to an associated RACH occasion. Further, the RACH preamble is transmitted at the RACH occasion associated with the target SSB beam.

For at least wireless communication networks with large numbers of SSB beams, it has been appreciated that there will often be SSB beams with signal strengths similar to the greatest signal strength and that these SSB beams will often be associated with RACH occasions spaced across the association period. Therefore, there may be multiple candidate SSB beams with associated RACH occasions spaced across the association period. Further, selecting the target SSB beam as a candidate SSB beam with the least amount of RACH delay may yield a reduction in RACH delay compared to merely selecting the target SSB beam as a configured SSB beam with a greatest signal strength.

In addition to reducing RACH delay, smart SSB beam selection may generally be performed without any significant impact on performance of a UE (e.g., battery life). The signal strength measurements used for selection of candidate SSB beams are generally collected already in 5G networks and the like. Further, the target SSB beam selection does not depend on any additional measurements or significant processing since the associations between SSB beams and RACH occasions are known.

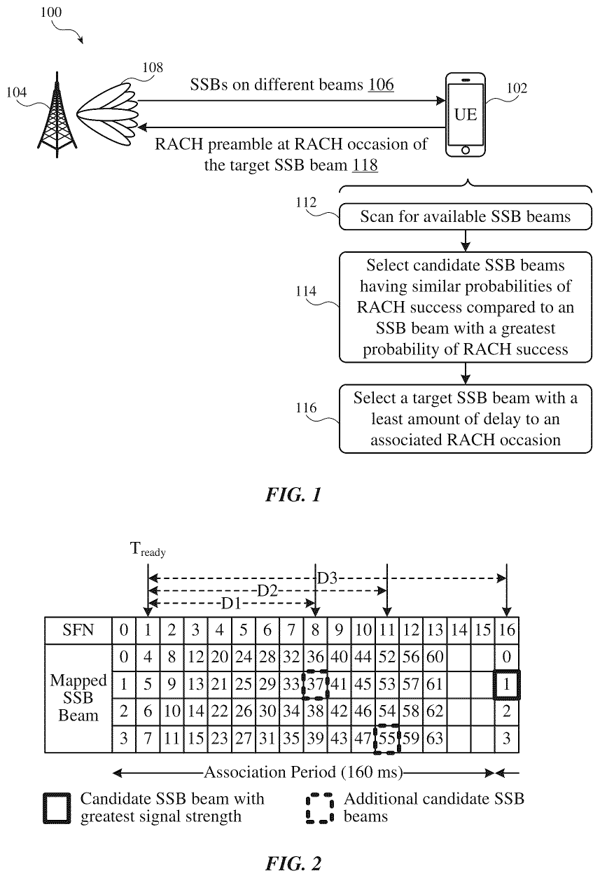

FIG. 1 illustrates a diagram of an example of a wireless communication network 100 with smart SSB beam selection to minimize RACH delay. The wireless communication network 100 includes a UE 102 and a Radio Access Network (RAN) node 104. The wireless communication network 100 may, for example, be a 4G or LTE network, a 5G or NR network, and so on. The RAN node 104 may, for example, be an Evolved Node B (e.g., eNB) base station, a Next Generation Node B (e.g., gNB) base station, or the like. The UE 102 may, for example, be a smartphone, a laptop, or the like.

The RAN node 104 transmits a plurality of SSBs 106 via a plurality of beams 108 (also known as SSB beams), which are associated with a plurality of RACH occasions. Each of the plurality of SSBs 106 is transmitted on a different one of the plurality of SSB beams 108, and each of the plurality of SSB beams 108 is associated with at least one of the plurality of RACH occasions. In an example, the plurality of SSBs 106 correspond to an SSB burst, which may be transmitted periodically. For example, the SSB burst may be transmitted every 10 ms, 20 ms, 40 ms, or some other suitable amount of time. Further, in an example, the plurality of RACH occasions correspond to an association period, which repeats over time. The association period may, for example, be as described at section 8.1 in 3GPP TS 38.213 v17.11.0 and/or may have a maximum allowed value of 160 ms.

At act 112, the UE 102 scans for the plurality of SSB beams 108 to identify a plurality of available SSB beams, each associated with a RACH occasion. The plurality of available SSB beams correspond to SSB beams that are detected by the UE 102 and may include some or all of the plurality of SSB beams 108. Further, the UE 102 receives the SSBs of the available SSB beams and measures the signal strengths of the plurality of available SSB beams based on the received SSBs of the available SSB beams. Signal strength may, for example, correspond to RSRP or the like.

At act 114, the UE 102 selects one or more candidate SSB beams from the plurality of available SSBs. The one or more candidate SSB beams are selected as SSB beams with similar probabilities of RACH success compared to an available SSB beam with a greatest (e.g., best) probability of RACH success. RACH success may, for example, correspond to the UE 102 receiving a RACH response (e.g., a Msg2 response) from the RAN node 104 in response to a RACH preamble transmission (e.g., a Msg1 transmission). Similarly, RACH failure may, for example, correspond to the UE 102 not receiving a RACH response from the RAN node 104 in response to the RACH preamble transmission.

In an example, the one or more candidate SSB beams include only one or more SSB beams having the greatest probability of RACH success. In another example, the one or more candidate SSB beams include the one or more SSB beams having the greatest probability of RACH success and further include one or more additional SSB beams having similar probabilities of RACH success compared to the greatest probability.

In some aspects, probability of RACH success is approximated by signal strength. Greater signal strengths indicate greater probabilities of RACH success, and smaller signal strengths indicate smaller probabilities of RACH success. Further, in some aspects, similarity between two values is determined by whether the two value are within a threshold amount of each other. Two values are similar when within the threshold amount of each other and are otherwise dissimilar. Therefore, in some aspects, the one or more candidate SSB beams may be selected as SSB beams with signal strengths within a threshold amount of a greatest (e.g., best) signal strength of the plurality of available SSB beams.

As explained hereafter, the threshold amount may be varied over time based on historical RACH failure rates, distance between the UE 102 and the RAN node 104, and other suitable parameters. Generally, the larger the threshold amount, the more candidate SSB beams and the more the reduction in RACH delay. Further, the smaller the threshold amount, the less candidate SSB beams but the higher the likelihood of RACH success.

At act 116, the UE 102 selects a target SSB beam from the one or more candidate SSB beams. The target SSB beam is selected by selecting an SSB beam with a least amount of delay to an associated RACH occasion. The amount of delay may be determined by using the known mapping between SSB beam and RACH occasion.

With the target SSB beam selected, the UE 102 transmits a RACH preamble 118 (e.g., a Msg1 transmission) to the RAN node 104. The RACH preamble 118 is transmitted at the RACH occasion associated with the target SSB beam. Such transmission may be part of a contention-based RACH process or some other suitable process.

Transmission of the RACH preamble implicitly identifies the target SSB beam to the RAN node 104 and more generally to the wireless communication network 100. For example, the RAN node 104 can map the RACH occasion on which the RACH preamble is received to the target SSB beam using the known associations between SSB beams and RACH occasions. Further, once the RAN node 104 knows the target SSB beam, the RAN node 104 can beam form subsequent transmissions to the UE 102 on the target SSB beam or on another SSB beam selected based on the target SSB beam.

In an example, the wireless communication network 100 is configured with a large number of SSB beams. A large number of SSB beams may, for example, correspond to 16, 24, 32, 56, or more SSB beams. Further, 5 G FR2 networks and the like often have a large number of SSB beams, whereby the wireless communication network 100 may be a 5 G FR2 networks or the like in at least some examples.

At least where the wireless communication network 100 has a large number of SSB beams, it has been appreciated that there will often be SSB beams with signal strengths similar to the greatest signal strength and hence with similar probabilities of RACH success to the SSB beam with the greatest signal strength. Further, it has been appreciated that these SSB beams will often be associated with RACH occasions spaced across the association period. Therefore, the selection at act 114 may yield multiple candidate SSB beams with associated RACH occasions spaced across the association period.

Because there may be multiple candidate SSB beams with RACH occasions spaced across the association period, selecting the target SSB beam as a candidate SSB beam with the least amount of RACH delay may yield a reduction in RACH delay compared to selecting the target SSB beam as an available SSB beam with a greatest signal strength. For example, suppose an SSB beam with a greatest signal strength (e.g., a best SSB beam) has a RACH delay equal to the association period (e.g., the worst case). In this example, a candidate SSB beam with a similar signal strength to the best SSB beam would likely have a lesser RACH delay than the best SSB beam and may be selected as the target SSB beam instead of the best SSB beam to likely yield a reduction in RACH delay.

In addition to reducing RACH delay, smart SSB beam selection may generally be performed without any significant impact on performance of the UE 102 (e.g., battery life). The signal strength measurements used for selection of candidate SSB beams are generally collected already in 5G networks and the like. Further, the target SSB beam selection does not depend on any additional measurements or significant processing since the associations between SSB beams and RACH occasions are known and preconfigured.

FIG. 2 illustrate an example of smart SSB beam selection using an example mapping between RACH occasions and SSB beams. Seventeen System Frame Numbers (SFNs) are illustrated and have individual SFN indexes 0-16 that increase along a horizontal axis, which corresponds to increasing time from left to right. Further, each of the SFNs has RACH occasions sufficient to accommodates four SSB beams. For example, each of the SFNs has two RACH occasions that are time multiplexed together, and each RACH occasion is associated with two SSB beams. Alternatively, depending on network configuration, there may be more or less SSB beams per SFN. For example, there may be more or less of SSB beams per RACH occasion and/or more or less RACH occasions per SFN.

Fifty-six SSB beams are mapped to RACH occasions of an association period. The association period repeats periodically over time, such that each mapping between SSB beam and RACH occasion repeats periodically with the association period. The association period spans sixteen SFNs, which are each 10 ms, such that the association period is 160 ms. Alternatively, the association period may span a different number of SFNs. The association period generally corresponds to the minimum period with a sufficient number of RACH occasions to allow every SSB beam to be mapped to a RACH occasion at least once. In an example, the association period may be as described at section 8.1 in 3GPP TS 38.213 v17.11.0 and/or may have a maximum allowed value of 160 ms.

The fifty-six SSB beams have individual beam indexes 0-15, 20-47, and 52-63.Notably, beam indexes 16-19 and 48-51 are omitted since the SSB beams with these indexes are disabled in the present example. The SSB beams are mapped over time in increasing order of beam index to the RACH occasions of the association period. Hence, SFN 0 has SSB beams with beam indexes 0-3, SFN 1 has SSB beams with beam indexes 4-7, and so on. In an example, the mapping between SFN and SSB beam may, for example, be as described at section 8.1 in 3GPP TS 38.213v17.11.0 .

During smart SSB beam selection, a UE (e.g., 102 in FIG. 1) measures the signal strengths of the SSB beams. Further, the UE selects one or more candidate SSBs having similar signal strengths and hence similar probabilities of RACH success. In this example, the UE selects SSB beam 1, which has a greatest (e.g., best) signal strength amongst individual signal strengths of the SSB beams. Further, the UE selects SSB beam 37 and SSB beam 55, which have individual signal strengths that are less than but similar to the greatest signal strength. As noted above, similarity is assessed by with the individual signal strengths are within a threshold amount of the greatest signal strength.

In an example, SSB beam 1 has an RSRP of −73 decibel-milliwatts (dBm), SSB beam 37 has an RSRP of −75 dBm, SSB 55 has an RSRP of −74 dBM, and all other SSBs have RSRPs less than −75 dBm. Hence, the threshold amount may, for example, be 2 or some other suitable value. Notwithstanding these specific RSRP values and the threshold-amount value, other suitable values are amenable.

Supposing the UE is ready for RACH preamble transmission at time T_{ready}, the UE selects the candidate SSB with a least amount of RACH delay. RACH delay for an SSB beam corresponds to the time difference between when the UE is ready for RACH preamble transmission (e.g., T_{ready}) and when the next RACH occasion for the SSB beam is. In this example, SSB beam 37 has a RACH delay of D1, SSB beam 55 has a RACH delay of D2, and SSB beam 1 has a RACH delay of D3. Because D1 is the smallest RACH delay amongst RACH delays D1, D2, and D3, the UE selects SSB beam 37 as the target SSB beam and performs RACH preamble transmission at the RACH occasion of SSB beam 37.

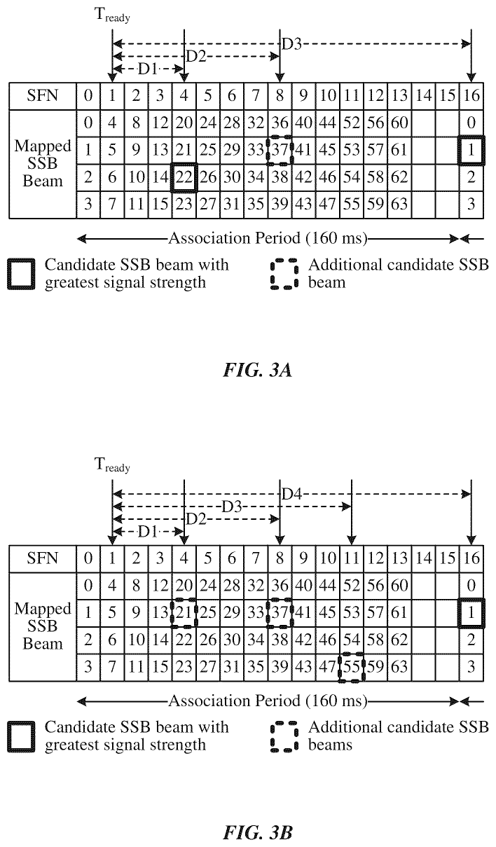

FIGS. 3A and 3B illustrate additional examples of smart SSB beam selection using an example mapping between RACH occasions and SSB beams. The example mapping may, for example, be as described with regard to FIG. 2. However, in contrast with FIG. 2, the candidate SSB beams selected during smart SSB beam selection are different.

In the example of FIG. 3A, the UE selects SSB beam 1, SSB beam 22, and SSB beam 37 as candidate SSB beams. SSB beam 1 and SSB beam 22 share a greatest (e.g., best) signal strength amongst individual signal strengths of the SSB beams. Further, SSB beam 37 has a signal strength that is less than but similar to the greatest signal strength. Thereafter, the UE selects the candidate SSB beam with a least amount of RACH delay. In this example, SSB beam 22 has a RACH delay of D1, SSB beam 37 has a RACH delay of D2, and SSB beam 1 has a RACH delay of D3. Because D1 is the smallest RACH delay amongst RACH delays D1, D2, and D3, the UE selects SSB beam 22 as the target SSB beam and performs RACH preamble transmission at the RACH occasion of SSB beam 22.

In the example of FIG. 3B, the UE selects SSB beam 1, SSB beam 21, SSB beam 37, and SSB beam 55 as candidate SSB beams. SSB beam 1 has a greatest (e.g., best) signal strength amongst individual signal strengths of the SSB beams. Further, SSB beam 21, SSB beam 37, and SSB beam 55 have individual signal strengths that are less than but similar to the greatest signal strength. Thereafter, the UE selects the candidate SSB beam with a least amount of RACH delay. In this example, SSB beam 21 has a RACH delay of D1, SSB beam 37 has a RACH delay of D2, SSB beam 55 has a RACH delay of D3, and SSB beam 1 has a RACH delay of D4. Because D1 is the smallest RACH delay amongst RACH delays D1, D2, D3, and D4, the UE selects SSB beam 21 as the target SSB beam and performs RACH preamble transmission at the RACH occasion of SSB beam 21.

Thus far, the discussion of smart SSB beam selection has focused on SSB beams. However, in at least some aspects, SSB beams correspond one-to-one to SSBs of an SSB burst, where the SSB burst repeats periodically. Therefore, SSB beams and SSBs of an SSB burst may be regarded as interchangeable in at least some aspects.

In an example, the mapping between SSB beam and RACH occasion in FIGS. 2, 3A, and 3B may also be regarded as a mapping between SSB of an SSB burst and RACH occasion. In another example, smart SSB beam selection may comprise: 1) receiving a plurality of SSBs of an SSB burst via a plurality of SSB beams, respectively, wherein the plurality of SSBs are each associated with a RACH occasion; 2) selecting one or more candidate SSBs from the plurality of SSBs and as SSBs associated with SSB beams having signal strengths within a threshold amount of a greatest signal strength of the plurality of SSB beams; 3) selecting a target SSB from the one or more candidate SSBs as an SSB with a least amount of delay to an associated RACH occasion; and 4) transmitting a RACH preamble at the RACH occasion associated with the target SSB.

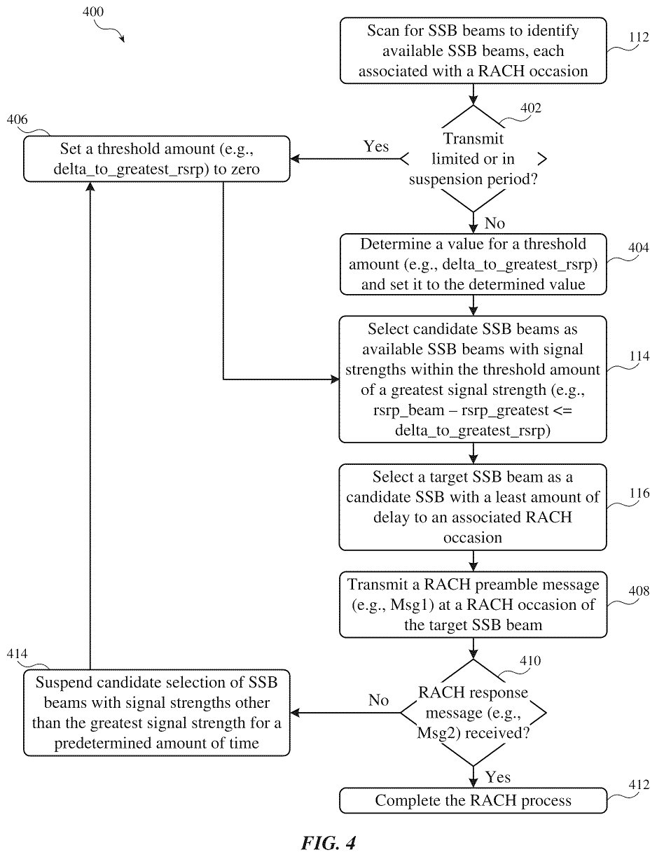

FIG. 4 illustrates a flow diagram of an example of a method 400 for smart SSB beam selection. The method may, for example, be performed by a UE, such as, for example, the UE 102 of FIG. 1 or some other suitable device.

At act 112, the UE scans for SSB beams to identify a plurality of available SSB beams, each associated with a RACH occasion. This may, for example, include measuring individual signal strengths of the plurality of available SSB beams using the SSBs transmitted with the plurality of SSB beams. The plurality of available SSB beams correspond to SSB beams that are detected by the UE 102 and may, for example, correspond to some or all of the SSB beams configured on the network.

At act 402, a determination is made as to whether the UE is transmit limited or in a suspension period. The UE may be transmit limited if a transmit power calculated for RACH transmission (e.g., a calculated RACH power) exceeds a maximum transmit power limit configured by the network. As to the suspension period, it will hereafter be seen that candidate selection of SSB beams with signal strengths other than the greatest (e.g., best) signal strength may be suspended for a predetermined amount of time.

If the UE is not transmitted limited and is not in a suspension period, a value is determined for a threshold amount (e.g., delta_to_greatest_rsrp), and the threshold amount is set to the value, at act 404. As seen hereafter, the threshold amount is used for assessing similarity between probabilities of RACH success for SSB beams, and/or similarity between signal strengths for SSB beams, during selection of candidate SSB beams. In an example, the threshold amount may be set to 2, 4, or some other suitable value.

Further details on determining the value for the threshold amount follow but the value may be determined based on one or more factors to maximize the probability of RACH success. Such factors may, for example, include historical RACH failure rates, distance between the UE and the RAN node, and other suitable parameters. Generally, the larger the value of the threshold amount, the more candidate SSB beams are selected and the more the reduction in RACH delay. Further, the smaller the value of the threshold amount, the less candidate SSB beams are selected but the higher the likelihood of RACH success.

If the UE is transmitted limited or is in a suspension period, the threshold amount (e.g., delta_to_greatest_rsrp) is set to zero at act 406. This has the effect of disabling candidate selection of SSB beams with signal strengths other than the greatest (e.g., best) signal strength. Being transmitted limited may mean signal strength is poor, and hence the calculated RACH power is high, so use of an SSB beam with the greatest signal strength may be used to minimize RACH failure. Further, as seen hereafter, the suspension period is invoked by previous RACH failure, so use of an SSB beam with the greatest signal strength may be again used to minimize RACH failure.

At act 114, one or more candidate SSB beams are selected from the plurality of available SSBs. The one or more candidate SSB beams are selected as SSB beams with signal strengths (e.g., rsrp_beam) within the threshold amount (e.g., delta_to_greatest_rsrp) of a greatest signal strength (e.g., rsrp_greatest). Put another way, the one or more candidate SSB beams are selected as SSB beams meeting rsrp_beam−rsrp_greatest<=delta_to_greatest_rsrp. When the threshold amount is zero, the one or more candidate SSB beams include only one or more SSB beams having the greatest signal strength. When the threshold amount is non-zero, the one or more candidate SSB beams include the one or more SSB beams having the greatest signal strength and may further include zero, one, or more SSB beams with signal strengths similar to the greatest signal strength.

At act 116, a target SSB beam is selected from the one or more candidate SSB beams by selecting an SSB beam with a least amount of delay to an associated RACH occasion. FIGS. 2, 3A, and 3B provide non-limiting examples of this.

At act 408, a RACH preamble (e.g., Msg1) is transmitted at the RACH occasion associated with the target SSB beam. The RACH-preamble transmission may, for example, be part of a contention-based RACH process or the like.

At act 410, a determination is made as to whether a RACH response (e.g., Msg2) is received in response to the RACH-preamble transmission. If no RACH response is received, the RACH-preamble transmission may be regarded as failing. Otherwise, the RACH-preamble transmission may be regarded as succeeding.

If the RACH response is received (e.g., the RACH-preamble transmission succeeds), a remainder of the RACH process being performed is completed at act 412. For example, supposing the RACH-preamble transmission is part of a contention-based RACH process or the like, a remainder of the contention-based RACH process may be completed, including transmitting Msg3 and receiving Msg4.

If the RACH response is not received (e.g., the RACH-preamble transmission fails), candidate selection of SSB beams with signal strengths other than the greatest signal strength is suspended at act 414 for a predetermined amount of time. During this suspension period, the threshold amount (e.g., delta_to_greatest_rsrp) is restricted to zero.

Additionally, if the RACH response is not received, the method proceeds to act 406 for retransmission of the RACH preamble. Because the threshold amount is restricted to zero, the one or more candidate SSB beams selected at act 114 are restricted to the one or more available SSB beams having the greatest signal strength. This increases the likelihood of RACH success during the retransmission.

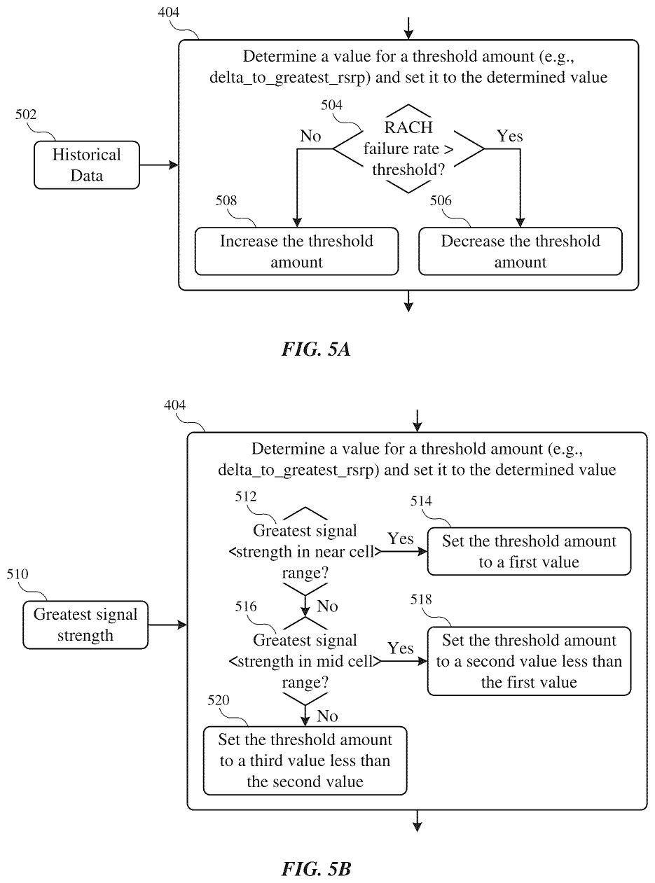

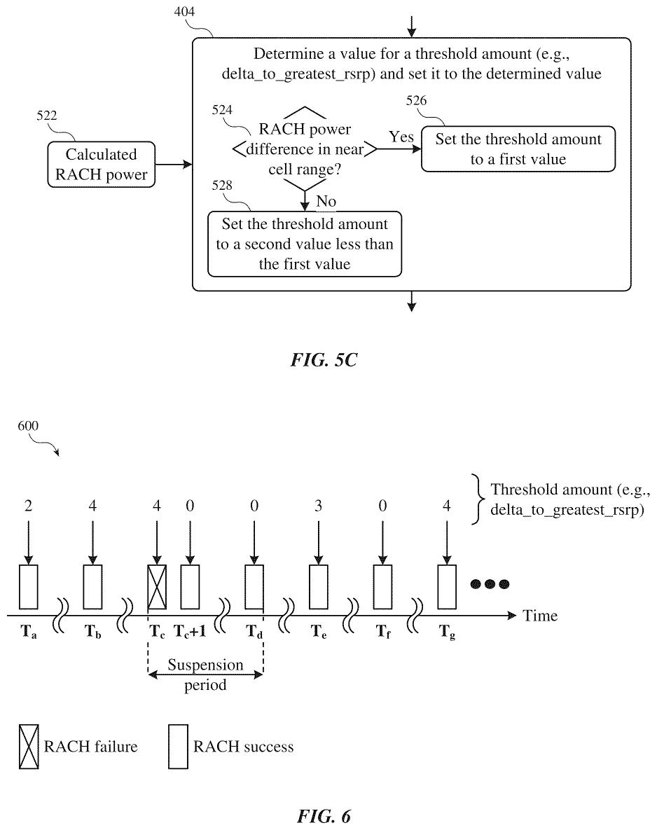

FIGS. 5A-5C illustrate flow diagrams of examples of setting the threshold amount (e.g., delta_to_greatest_rsrp) for candidate SSB beam selection. The examples in FIGS. 5A-5C may, for example, further define act 404 in FIG. 4.

In the example of FIG. 5A, the threshold amount is set based on historical data 502. The historical data includes failure rates for past RACH-preamble transmissions. Success occurs when a RACH response (e.g., Msg2) is received in response to a RACH-preamble transmission (e.g., Msg1) and failure otherwise occurs.

At act 504, a determination is made as to whether the historical failure rate exceeds a predetermined threshold. Alternatively, a determination is made as to whether a historical success rate exceeds a predetermined threshold. In an example, the historical failure rate is calculated as the number of failed RACH-preamble transmissions divided by the total number of RACH-preamble transmissions and is calculated over the last X number of time units (e.g., seconds, minutes, etc.) or over the last X number of RACH-preamble transmissions, where X is a configurable number.

If the historical failure rate is more than the predetermined threshold, the threshold amount (e.g., delta_to_greatest_rsrp) may be decreased at act 506 by one or some other suitable amount from its last non-zero value. Decreasing the threshold amount increases the degree to which an SSB beam must be similar to the SSB beam with the greatest signal strength for it to be selected as a candidate SSB beam. This may reduce the number of candidate SSB beams but may increase the likelihood of RACH success.

If the historical failure rate is less than the predetermined threshold, the threshold amount may be increased at act 508 by one or some other suitable amount. In some aspects, the threshold amount is increased from its last value (even if zero). In other aspects, the threshold amount is increased from its last non-zero value. Increasing the threshold amount decreases the degree to which an SSB beam must be similar to the SSB beam with the greatest signal strength for it to be selected as a candidate SSB beam. This may increase the number of candidate SSB beams, which may reduce the amount of RACH delay.

In the example of FIG. 5B, the threshold amount is set based on a greatest signal strength 510, which approximates a physical distance between the UE and the RAN node. The greatest signal strength is “greatest” from amongst individual signal strengths of the plurality available SSB beams and may, for example, correspond to RSRP or the like.

At act 512, a determination is made as to whether the greatest signal strength 510 is within a near cell range. If the greatest signal strength 510 is within the near cell range, the threshold amount (e.g., delta_to_greatest_rsrp) is set to a first value at act 514. Otherwise, a determination is made at act 516 as to whether the greatest signal strength 510 is within a mid cell range. If the greatest signal strength 510 is within the mid cell range, the threshold amount is set to a second value less than the first value at act 518. Otherwise, the greatest signal strength 510 is assumed to be within a far cell range and is set to a third value less than the second value at act 520. In an example, the near cell range is more than −65 dBm, the mid cell range is −65 dBm to −105 dBm, and the far cell range is less than −105 dBm Further, in an example, the first value is 4, the second value is 2, and the third value is 0.

From the near cell range to the far cell range, signal strength decreases and the threshold amount decreases. A lower value for the threshold amount generally increases the likelihood of successful RACH transmission, whereas a higher value for the threshold amount generally reduces the amount of RACH delay. Therefore, decreasing the threshold amount as signal strength decreases generally counters the decreasing likelihood of successful RACH transmission at the cost of increased RACH delay.

In the example of FIG. 5C, the threshold amount is set based on a difference from subtracting the calculated RACH power 522 from a maximum transmit power limit. Said difference may also be known as a RACH power difference or the like. The calculated RACH power 522 corresponds to the transmit power calculated or otherwise determined for RACH preamble transmission. Further, the maximum transmit power limit may, for example, be configured by the network or predefined.

At act 524, a determination is made as to whether the RACH power difference is within a near cell range. If the RACH power difference is within the near cell range, the threshold amount (e.g., delta_to_greatest_rsrp) is set to a first value at act 526. Otherwise, the RACH power difference is assumed to be within in a mid cell range and is set to a second value less than the first value at act 528. In an example, the near cell range is more than 10 decibels (dB) and the mid cell range is 0 dB to 10 dB. Further, in an example, the first value is 4 and the second value is 2. Note that acts 402 and 406 in FIG. 4 may, for example, be regarded as covering a far cell scenario where the RACH power difference is less than zero and set the threshold amount to a third value (e.g., zero) less than the second value.

FIG. 6 illustrates a timing diagram 600 of an example of the threshold amount (e.g., delta_to_greatest_rsrp) for candidate SSB beam selection varying over time. The horizontal axis corresponds to time and includes a plurality of times. Further, the plurality of times are respectively labeled Tₐ, T_{b}, T_{c}, T_{c+1}, and so on to T_{g}.

At each time, a RACH preamble transmission (illustrated as a block) is performed at the RACH occasion associated with a target SSB beam selected by the method for smart SSB beam selection in FIG. 4. Failure of a RACH-preamble transmission is indicated by an “X” on the corresponding block, and success of a RACH-preamble transmission is indicated by the lack of an “X” on the corresponding block. The RACH preamble transmission may be triggered for a number of reasons, including an initial connection to a network, connection to the network after a period of inactivity, handover between cells, and so on.

At time Tₐ, act 404 in FIG. 4 sets the threshold amount to a value of 2 and subsequently RACH preamble transmission succeeds. The threshold amount may, for example, be set to 2 because the greatest signal strength is in a mid cell range, as described with FIG. 5B. Alternatively, the threshold amount may, for example, be set to 2 because the RACH power difference is in a mid cell range, as described with FIG. 5C.

At time T_{b}, act 404 in FIG. 4 sets the threshold amount to 4 and subsequently RACH preamble transmission succeeds. The threshold amount may, for example, be set to 4 because the greatest signal strength is in a near cell range, as described with FIG. 5B. Alternatively, the threshold amount may, for example, be set to 4 because the RACH power difference is in a near cell range, as described with FIG. 5C.

At time T_{c}, act 404 in FIG. 4 sets the threshold amount to a value of 4 and subsequently RACH preamble transmission fails. This suspends selection of SSB beams with signal strengths other than the greatest signal strength for a predetermined amount of time at act 414 in FIG. 4. Further, the RACH preamble transmission is repeated and succeeds at time T_{c+1} with the threshold amount set to 0. As noted above, with the threshold amount set to 0, only SSB beams with the greatest signal strength may be selected as candidates.

At time T_{d}, the suspension is still in effect (e.g., time T_{d} is within a suspension period). As such, the threshold amount is set to 0 at act 406 in FIG. 4 and subsequently RACH preamble transmission succeeds.

At time Tₑ, the suspension has ended. Further, act 404 in FIG. 4 sets the threshold amount to a value of 3 and subsequently RACH preamble transmission succeeds. The threshold amount may, for example, be set to 3 by decrementing the last non-zero value of 4 based on a failure rate, as described with FIG. 5A.

At time T_{f}, act 406 in FIG. 4 sets the threshold amount to 0 and subsequently RACH preamble transmission succeeds. Because there is no suspension in effect, the threshold amount is set to 0 because the UE is transmitted limited.

At time T_{g}, act 404 in FIG. 4 sets the threshold amount to a value of 4 and subsequently RACH preamble transmission succeeds. The threshold amount may, for example, be set to 4 by incrementing the previous non-zero value of 3 based on failure rate, as described with FIG. 5A. Alternatively, the threshold amount may, for example, be set to 4 because the greatest signal strength is in a near cell range, as described with FIG. 5B. Alternatively, the threshold amount may, for example, be set to 4 because the RACH power difference is in a near cell range, as described with FIG. 5C.

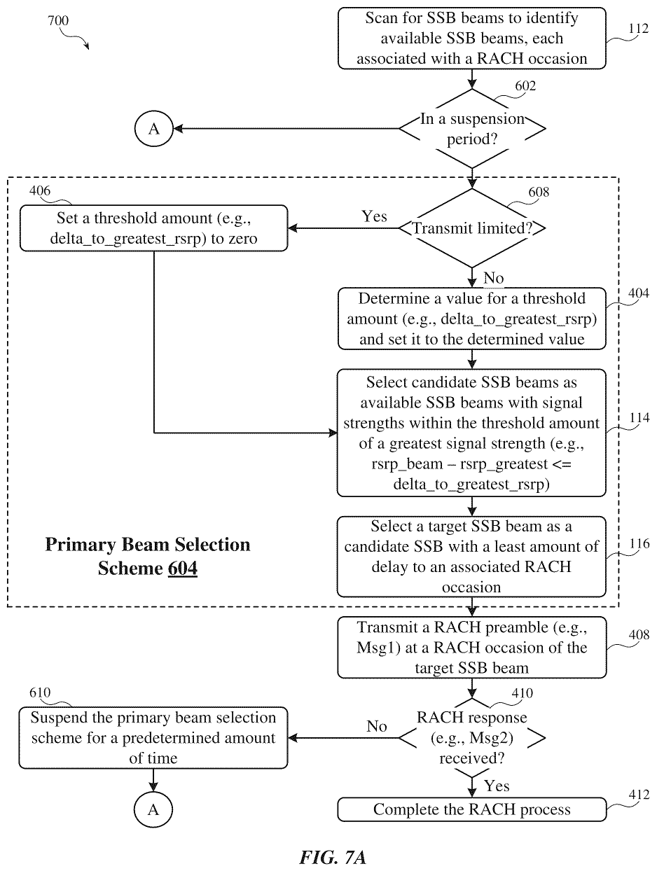

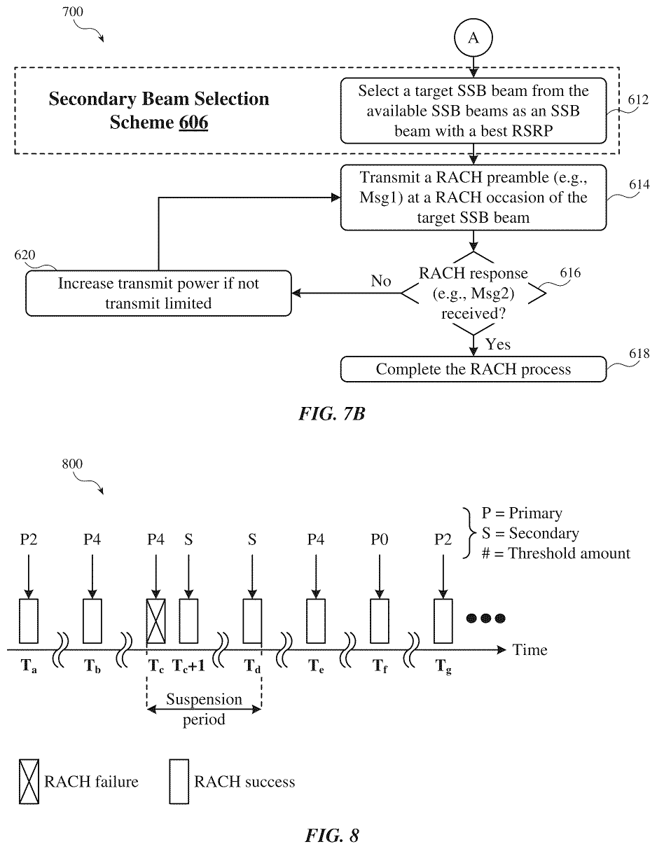

FIGS. 7A and 7B illustrate a flow diagram of an example of a method 700 for smart SSB beam selection. FIG. 7A corresponds to a first portion of the flow diagram, and FIG. 7B corresponds to a second portion of the flow diagram. Further, the first and second portions are connected together by node A. The method 700 for smart SSB beam selection is similar to the method 400 of FIG. 4 but varies as noted hereafter.

After scanning for SSB beams at act 112, a determination is made at act 602 as to whether the UE is in a suspension period. If not in a suspension period, a primary beam selection scheme 604 (see FIG. 7A) is performed. If in a suspension period, a secondary beam selection scheme 606 (see FIG. 7B) is performed. As seen hereafter, suspension may be triggered by failure of RACH preamble transmission.

In accordance with the primary beam selection scheme 604, a determination is made at act 608 as to whether the UE is transmit limited. The UE may be regarded as being transmit limited if the calculated RACH power for RACH transmission exceeds the maximum transmit power limit configured by the network. If transmitted limited, act 406 is performed to set the threshold amount (e.g., delta_to_greatest_rsrp) to zero. Otherwise, act 404 is performed to determine a value for the threshold amount and to set the threshold amount to the determined value. FIGS. 5A-5C illustrate non-limiting examples of act 404 and how the threshold amount may be determined and set. After setting the threshold amount, acts 114 and 116 are performed as described with FIG. 4 to select a target SSB beam.

At act 408, a RACH preamble (e.g., Msg1) is transmitted at the RACH occasion associated with the target SSB beam. The RACH-preamble transmission may, for example, be part of a contention-based RACH process or the like.

At act 410, a determination is made as to whether a RACH response (e.g., Msg2) is received in response to the RACH-preamble transmission. In response to receipt of the RACH response (e.g., RACH success), a remainder of the RACH process being performed is completed at act 412. Otherwise (e.g., RACH failure), the primary beam selection scheme 604 is suspended at act 610 for a predetermined amount of time. Further, the secondary beam selection scheme 606 is performed.

In accordance with the secondary beam selection scheme 606, an SSB beam with a greatest signal strength (e.g., RSRP) is selected at act 612 from the plurality of available SSB beams and is used as a target SSB beam. No candidate selection is first performed. Alternatively, the secondary beam selection scheme 606 may implement some other series of acts different than those of the primary beam selection scheme 604.

At act 614, a RACH preamble (e.g., Msg1) is transmitted at the RACH occasion associated with the target SSB beam. The RACH-preamble transmission may, for example, be part of a contention-based RACH process or the like.

At act 616, a determination is made as to whether a RACH response (e.g., Msg2) is received in response to the RACH-preamble transmission. In response to receipt of the RACH response, a remainder of the RACH process being performed is completed at act 618. Otherwise, the transmit power may be increased at act 620 if not already at the maximum transmit power limit. Further, the RACH preamble transmission at act 614 may be repeated. Alternatively, the increase in transmit power at act 620 may be omitted.

FIG. 8 illustrates a timing diagram 800 of an example of a threshold amount for candidate SSB beam selection varying over time. The timing diagram 800 is similar to the timing diagram 600 of FIG. 6, except each RACH preamble transmission (illustrated as a block) is performed at the RACH occasion associated with a target SSB beam selected by the method of FIGS. 7A and 7B.

The beam selection scheme for a RACH preamble transmission is denoted by either a “P” or an “S”. P refers to the primary beam selection scheme 604 of FIG. 7A and is further suffixed with a number representing the threshold amount for candidate SSB beam selection (e.g., delta_to_greatest_rsrp). On the other hand, “S” refers to the secondary beam selection scheme 606 of FIG. 7B and is not suffixed with a number since the secondary beam selection scheme 606 does not use the threshold amount.

At time Tₐ, the primary beam selection scheme 604 is employed and the threshold amount is set to 2 at act 404 in FIG. 7A. Further, RACH preamble transmission succeeds.

At time T_{b}, the primary beam selection scheme 604 is employed and the threshold amount is set to 4 at act 404 in FIG. 7A. Further, RACH preamble transmission succeeds.

At time T_{c}, the primary beam selection scheme 604 is employed and the threshold amount is set to 4 at act 404 in FIG. 7A. Further, RACH preamble transmission fails. This suspends the primary beam selection scheme 604 for a predetermined amount of time at act 610 in FIG. 7A. Further, the RACH preamble transmission is repeated using the secondary beam selection scheme 606 and succeeds at time T_{c+1}. As noted above, the secondary beam selection scheme 606 selects a target SSB beam with the greatest signal strength without use of candidate beam selection and hence without use of the threshold amount.

At time T_{d}, the suspension is still in effect (e.g., time T_{d} is within a suspension period). As such, the secondary beam selection scheme 606 is employed and the RACH preamble transmission succeeds.

At time Tₑ, the suspension has ended, whereby the primary beam selection scheme 604 is employed with the threshold amount set to 4 at act 404 in FIG. 7A. Further, the RACH preamble transmission succeeds.

At time T_{f}, the primary beam selection scheme 604 is employed and the threshold amount is set to 0 at act 406 in FIG. 7A. Further, RACH preamble transmission succeeds. Because there is no suspension in effect and the threshold amount is set to 0, the UE is transmitted limited.

At time T_{g}, the primary beam selection scheme 604 is employed and the threshold amount is set to 2 at act 404 in FIG. 7A. Further, the RACH preamble transmission succeeds.

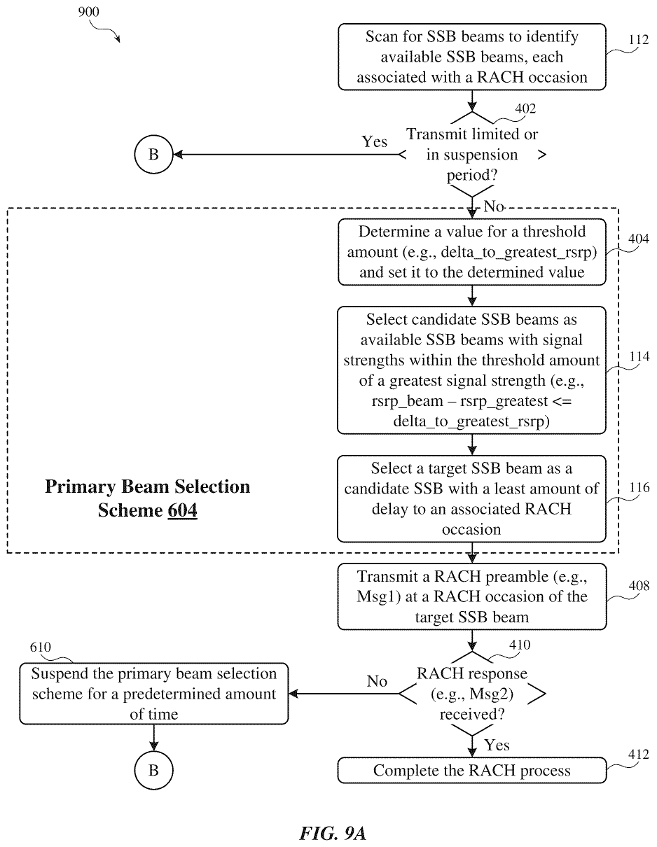

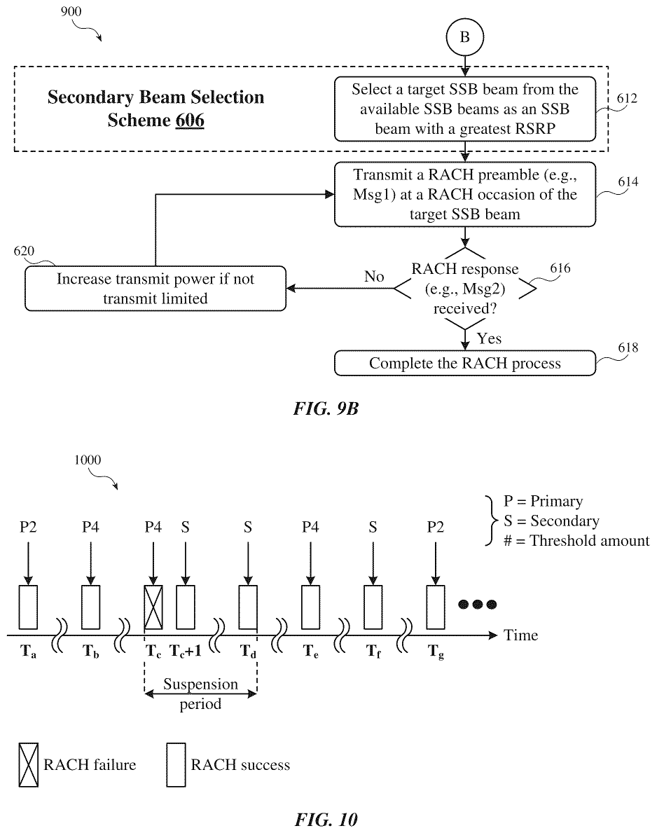

FIGS. 9A and 9B illustrate a flow diagram of an example of a method 900 for smart SSB beam selection. FIG. 9A corresponds to a first portion of the flow diagram, and FIG. 9B corresponds to a second portion of the flow diagram. Further, the first and second portions are connected together by node B. The method 900 for smart SSB beam selection is the same as or similar to the method 700 of FIGS. 7A and 7B, except the UE being transmit limited further shifts the method 900 to the secondary beam selection scheme 606.

For example, after scanning for SSB beams at act 112, a determination is made at act 402 as to whether the UE is transmit limited or in a suspension period. If not in a suspension period and not transmitted limited, the primary beam selection scheme 604 (see FIG. 9A) is performed. If in the suspension period or transmitted limited, the secondary beam selection scheme 606 (see FIG. 9B) is performed.

In accordance with the primary beam selection scheme 604, acts 404, 114, and 116 are performed as described with FIG. 4 to select a target SSB beam. At act 408, a RACH preamble (e.g., Msg1) is transmitted at the RACH occasion associated with the target SSB beam. Further, at act 410, a determination is made as to whether a RACH response (e.g., Msg2) is received in response to the RACH-preamble transmission. In response to receipt of the RACH response, a remainder of the RACH process is completed at act 412. Otherwise, the primary beam selection scheme 604 is suspended at act 610 for a predetermined amount of time. Further, the secondary beam selection scheme 606 is performed.

In accordance with the secondary beam selection scheme 606, act 612 is performed as described with FIG. 7B to select a target SSB beam. At act 614, a RACH preamble (e.g., Msg1) is transmitted at the RACH occasion associated with the target SSB beam. Further, at act 616, a determination is made as to whether a RACH response (e.g., Msg2) is received in response to the RACH-preamble transmission. In response to receipt of the RACH response, a remainder of the RACH process being performed is completed at act 618. Otherwise, the transmit power may be increased at act 620 if not already at the maximum transmit power limit. Further, the RACH preamble transmission at act 620 may be repeated. Alternatively, the increase in transmit power at act 618 may be omitted.

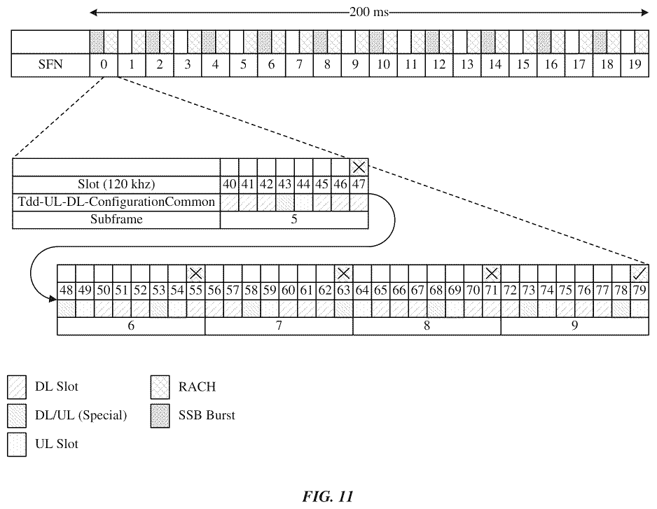

FIG. 10 illustrates a timing diagram 1000 of an example of a threshold amount for candidate SSB beam selection varying over time. The timing diagram 1000 is similar to the timing diagram 800 of FIG. 8, except each RACH preamble transmission (illustrated as a block) is performed at the RACH occasion associated with a target SSB beam selected by the method of FIGS. 9A and 9B.

Times Tₐ to Tₑ and time T_{g} are as described with regard to FIG. 8. However, at time T_{f}, the secondary beam selection scheme 606 is employed and the RACH preamble transmission subsequently succeeds. Because there is no suspension in effect and the UE is transmitted limited, the secondary beam selection scheme 606 is employed.

FIG. 11 illustrates a diagram of an example of a half-frame structure for use with smart SSB beam selection. Twenty SFNs have individual indexes 0-19 increasing along a horizontal axis, which corresponds to increasing time from left to right. The SFNs span 200 ms and are each 10 ms. Each of the SFNs has a RACH occasion in its second half, and every other SFN (e.g., each even numbered SFN) has an SSB burst in its first half. While only twenty SFNs are illustrated, there may be more SFNs. Further, the RACH occasions and the SSB bursts may have other periodicities, arrangements, etc.

The second half of each SFN (exemplified by the second half of SFN 0) includes five subframes, each including 8 slots. Hence, the subframes have a subcarrier spacing of 120 kilohertz (khz). Other subcarrier spacings are, however, amenable. The subframes have individual indexes 5-9, whereas the slots have individual indexes 40-79. Further, the subframes may, for example, be 1 ms each, whereas the slots may, for example, be 0.125 ms each. Other suitable values are, however, amenable.

Within the slots, certain slots are allocated for downlink (DL) communication (e.g., slots 50-52, 55-57, etc.), whereas certain slots are allocated for uplink (UL) communication (e.g., slots 49, 54, etc.). Further, certain slots are allocated for switching between uplink and download communication. These slots are designated as “DL/UL (Special)” slots and correspond to, for example, slots 48, 53, 58, and so on.

In this example, RACH occasions may only be at the last slot in each subframe. Hence, there are potentially five RACH slots per half frame. However, RACH preamble transmission can only be performed at slots allocated for uplink communication. Because four out of the potentially five RACH slots are allocated for download transmission or switching between uplink and downlink communication, these four slots are invalid RACH slots. There is only one potential RACH slot allocated for uplink transmission and hence only one valid RACH slot (e.g., slot 79). Alternatively, depending on how the slots are configured, there may be more valid RACH slots per half frame.

In an example, a UE performing smart SSB beam selection receives a slot configuration for the half-frame structure from the network. The slot configuration may, for example, be received via dedicated signaling or a System Information Block Type 1 (SIB1). The dedicated signaling may, for example, be by Radio Resource Control (RRC) or the like. In an example, the slot configuration includes TDD-UL-DL-ConfigCommon and RACH-ConfigCommon, which are Information Elements (IEs) as described at section 6.3.2 in 3GPP TS 38.331v17.9.0 . Note Tdd-UL-DL-ConfigCommon may also be known as Tdd-UL-DL-ConfigurationCommon. In an example, TDD-UL-DL-ConfigCommon facilitates slot configuration, as described at section 11.1 in 3GPP TS 38.213v17.11.0 , and/or RACH-ConfigCommon facilitates RACH-slot configuration.

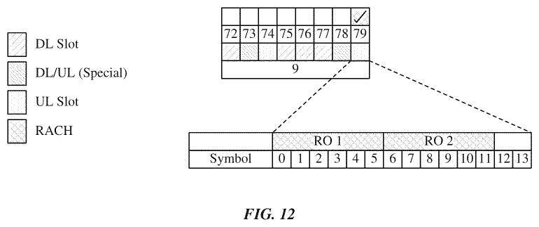

FIG. 12 illustrates a diagram of an example of RACH occasions within a RACH slot for use with smart SSB beam selection. The RACH slot corresponds to slot 79 in FIG. 11 and is representative of any valid RACH slot in FIG. 11. The RACH slot comprises fourteen Orthogonal Frequency-Division Multiplexing (OFDM) symbols, which are indexed 0-13. Alternatively, there may be more or less ODFM symbols per RACH slot.

The RACH slot has two time multiplexed RACH occasions. A first RACH occasion (e.g., RO 1) is at OFDM symbols 0-5, and a second RACH occasion (e.g., RO 2) is at OFDM symbols 6-11. The number of RACH occasions per RACH slot may vary based on the preamble format configured by the network. Shorter preamble formats may allow for more RACH occasions per RACH slot, whereas a longer preamble formats may allow for only one RACH occasion per RACH slot. While only time multiplexing is illustrated, there may additionally or alternatively be frequency multiplexing. For example, multiple RACH occasions may be multiplexed at the same time in the frequency domain.

As noted above, SSB beams are mapped to the to the RACH occasions. In an example, there may be two SSB beams per RACH occasion. Therefore, there may be four SSB beams per RACH slot and hence four SSB beams per SFN. Alternatively, depending on configuration, there may be more or less SSB beams per RACH occasion.

In an example, a UE performing smart SSB beam selection according to aspects of the present disclosure receives a RACH configuration for the illustrated RACH slot. The RACH configuration may, for example, be received via dedicated signaling or a SIB1. The dedicated signaling may, for example, be RRC or the like. In an example, the RACH configuration includes RACH-ConfigCommon, as described at section 6.3.2 in 3GPP TS 38.331v17.9.0 . RACH-ConfigCommon is an IE and may, for example, include a prach-ConfigurationIndex parameter, a msg1-FDM parameter, a ssb-perRACH-OccasionAndCB-PreamblesPerSSB parameter, and other suitable parameters.

In an example, the prach-ConfigurationIndex parameter identifies a row in a lookup table (e.g., one of Tables 6.3.3.2-2 to 6.3.3.2-4 in 3GPP TS 38.211v 17.9.0 ), which identifies a preamble format. Details regarding preamble formats may, for example, be as described at Table 6.3.3.1-2 3GPP TS 38.211v17.9.0 . In an example, the msg 1-FDM parameter indicates how many RACH occasions may be frequency multiplexed together at a given time. For example, the msg1-FDM parameter is one in FIG. 12 but could alternatively be 2, 4, or more. In an example, the ssb-perRACH-OccasionAndCB-PreamblesPerSSB parameter indicates how many SSBs may be mapped to a single RACH occasion. For example, the ssb-perRACH-OccasionAndCB-PreamblesPerSSB parameter is two in FIG. 12 but could alternatively be ⅛, ¼, ½, 1, 4, or more.

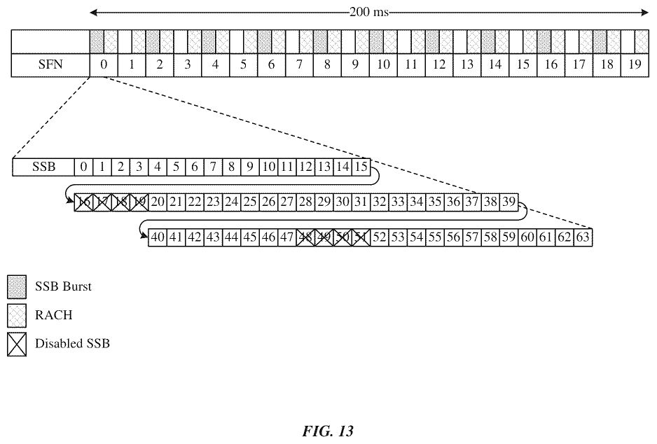

FIG. 13 illustrates a diagram of an example of an SSB burst for use with smart SSB beam selection. The example follows from the examples of FIGS. 11 and 12, whereby the illustrated SFNs are as described with FIGS. 11 and 12.

The SSB burst repeats at the first half of every other SFN (e.g., even numbered SFNs) and is exemplified by the first half of SFN 0. The SSB burst spans 5 ms and includes 64 SSBs, which are indexed 0-63 and which are temporality multiplexed. Further, some of the SSBs are disabled, as denoted by “X”, whereas other SSBs are enabled. Whether SSBs are enabled or disabled depends on how the network is configured. Because the configured SSBs (e.g., the enabled SSBs) are transmitted on different beams (e.g., SSB beams), there may be a one-to-one correspondence between the SSB beams and the SSBs of the SSB burst in at least some aspects of the present disclosure.

In an example, a UE performing smart SSB beam selection receives an SSB configuration for the illustrated SSBs and SSB burst. The SSB configuration may, for example, be received via dedicated signaling or a SIB1. The dedicated signaling may, for example, be RRC or the like. In an example, the SSB configuration includes ServingCellConfigCommon, as described at section 6.3.2 in 3GPP TS 38.331v17.9.0 . ServingCellConfigCommon is an IE and may, for example, include a ssb-PositionsInBurst parameter and a ssb-periodicityServingCell parameter.

In an example, the ssb-PositionsInBurst parameter identifies which SSBs are enabled and which SSBs are disabled. In the example of FIG. 13, the ssb-PositionsInBurst parameter has 64 bits corresponding to the SSBs, with “0 ” representing disabled and “1” representing enabled. The most significant bit corresponds to SSB 0 and the least significant bit corresponds to SSB 63. In an example, the ssb-periodicityServingCell parameters identifies a period of the SSB burst. For example, the ssb-periodicityServingCell parameters is 20 ms in FIG. 13 but could alternatively be 5 ms, 10 ms, or more.

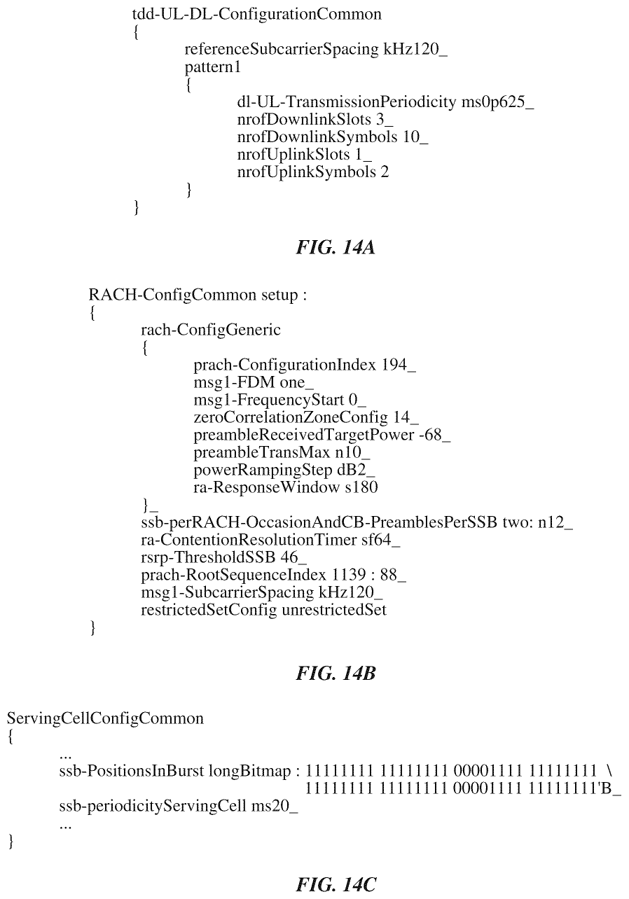

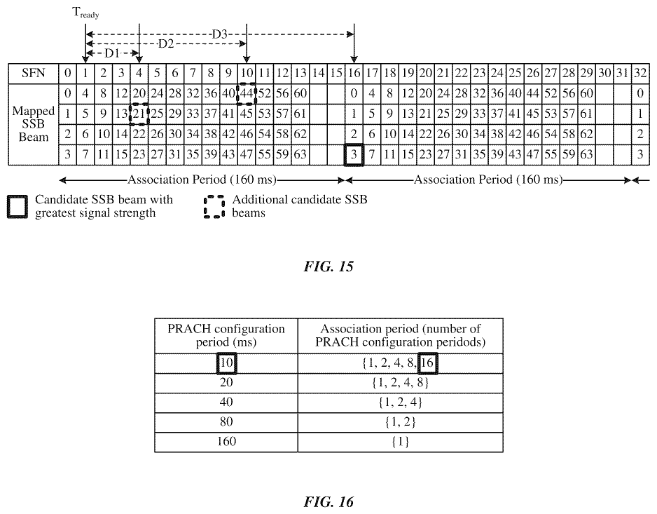

FIG. 14A-14C illustrates examples of various configurations for use with smart SSB beam selection. In FIG. 14A, values for the various parameters in Tdd-UL-DL-ConfigurationCommon are illustrated to achieve the slot configuration in FIG. 11. In FIG. 14B, values for the various parameters in RACH-ConfigCommon are illustrated to achieve the RACH configuration in FIGS. 11 and 12. In FIG. 14C, values for the various parameters in ServingCellConfigCommon are illustrated to achieve the SSB configuration in FIG. 13.

FIG. 15 illustrates an example of smart SSB beam selection using an example mapping between RACH occasions and SSB beams. The mapping is based on the slot, RACH, and SSB configurations described in FIGS. 11-13 and 14A-14C. In an example, these configurations correspond to a 5 G FR2 network or the like.

Thiry-three SFNs are illustrated and have individual indexes 0-32 that increase along a horizontal axis, which corresponds to increasing time from left to right. Further, each of the SFNs has RACH occasions sufficient to accommodates four SSB beams. For example, each of the SFNs has two RACH occasions that are time multiplexed together, and each RACH occasion is associated with two SSB beams. Alternatively, depending on how the network is configured there may be more or less SSB beams per SFN.

Fifty-six SSB beams are mapped to RACH occasions of an association period. The association period repeats periodically over time, such that each mapping between SSB beam and RACH occasion repeats periodically with the association period. The association period spans sixteen SFNs, which are each 10 ms, such that the association period is 160 ms. Alternatively, the association period may span a different number of SFNs. The association period generally corresponds to the minimum period with a sufficient number of RACH occasions to allow every SSB beam to be mapped to a RACH occasion at least once. In an example, the association period may be as described at section 8.1 in 3GPP TS 38.213 v17.11.0 and/or may have a maximum allowed value of 160 ms.

In some aspects, the association period is determined based on the example table in FIG. 16. In this example, a PRACH configuration period configured by the network is looked up in the example table to determine possible numbers of PRACH configuration periods per association period, and then the smallest number that allows each SSB beam to be mapped to at least one RACH occasion is selected. The selected number times the PRACH configuration period corresponds to the association period. As an example, a PRACH configuration period of 10 ms is configured (as highlighted in FIGS. 16) and 16 PRACH configuration periods are needed (also highlighted in FIG. 16) to map each SSB beam to a RACH occasion. Hence, the association period is 160 ms.

In an example, the PRACH configuration period may be configured by RACH-ConfigCommon (described above). For example, a prach-ConfigurationIndex parameter in RACH-ConfigCommon may identify a row in a lookup table (e.g., one of Tables 6.3.3.2-2 to 6.3.3.2-4 in 3GPP TS 38.211v17.9.0 ), which has a parameter value of x. The parameter value of x may, for example, correspond to the PRACH configuration period.

The fifty-six SSB beams correspond to the 56 SSBs per burst configured by the network and share indexes with the 56 SSBs. For example, SSB 1 is transmitted on SSB beam 1, which has a same index as SSB 1. Further, indexes 16-19 and 48-51 are omitted since the SSBs associated with these indexes are disabled in the present example. The SSB beams are mapped over time in increasing order of beam index to the RACH occasions of the association period. Hence, SFN 0 has SSB beams with beam indexes 0-3, SFN 1 has SSB beams with beam indexes 4-7, and so on. In an example, the mapping between SFN and SSB beam may, for example, be as described at section 8.1 in 3GPP TS 38.213v17.11.0 .

During smart SSB beam selection, and supposing the UE is ready for RACH preamble transmission at time T_{ready}, the UE selects one or more candidate SSB beams having individual signal strengths within a threshold amount of a greatest signal strength of the SSB beams. In this example, the UE selects SSB beam 3, which has the greatest signal strength. Further, the UE selects SSB beam 21 and SSB beam 44, which have individual signal strengths that within the threshold amount of the greatest signal strength.

Having selected the one or more candidate SSB beams, the UE selects the candidate SSB beam with a least amount of RACH delay. In this example, SSB beam 21 has a RACH delay of D1, SSB beam 44 has a RACH delay of D2, and SSB beam 3 has a RACH delay of D3. Because D1 is the smallest RACH delay amongst RACH delays D1, D2, and D3, the UE selects SSB beam 21 as the target SSB beam and performs RACH preamble transmission at the RACH occasion of SSB beam 21.

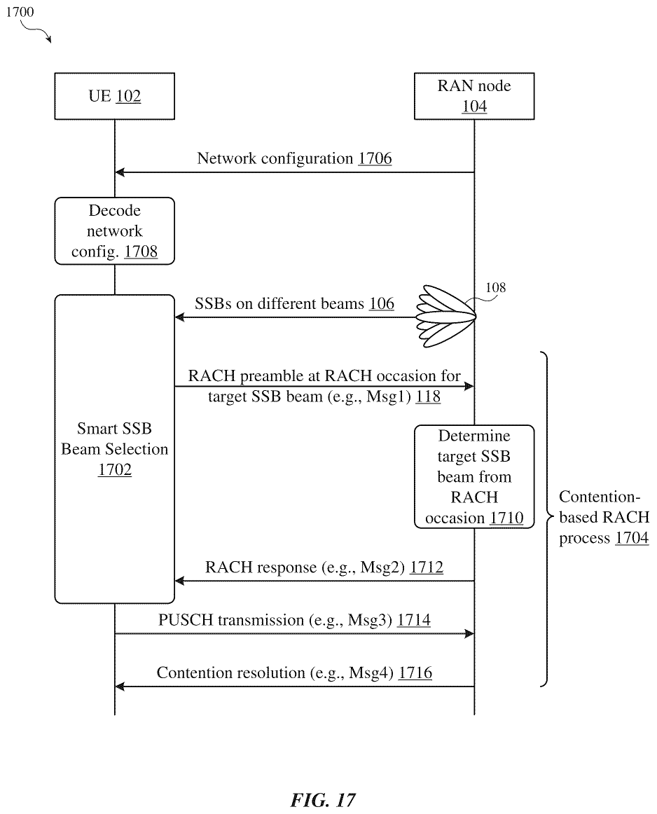

FIG. 17 illustrates a sequence diagram 1700 for example signaling in a wireless communication network during an example method, which includes smart SSB beam selection 1702 and a contention-based RACH process 1704. The wireless communication network includes a UE 102 and a RAN node 104 and may, for example, be a 4G or LTE network, a 5G or NR network (e.g., a 5 G FR 2 network or the like), and so on.

The RAN node 104 transmits a network configuration 1706 to the UE 102. Alternatively, the transmission may be split into multiple transmissions. The network configuration 1706 may, for example, be transmitted by dedicated signaling (e.g., RRC or the like) or by a SIB1. Further, the network configuration describes how slots, SSB bursts, and RACH are configured. In an example, the network configuration includes Tdd-UL-DL-ConfigurationCommon, RACH-ConfigCommon, and ServingCellConfigCommon, non-limiting examples of which are at FIGS. 14A-14C.

At act 1708, the UE 102 decodes the network configuration, which provides the UE with requisite information to scan for SSB beams, transmit on the network, and so on.

Thereafter, the RAN node 104 transmits a plurality of SSBs 106 via a plurality of beams 108 (also known as SSB beams) and the UE 102 performs the smart SSB beam selection 1702. The smart SSB beam selection 1702 may, for example, be performed according to the method of FIG. 4, the method of FIGS. 7A and 7B, or the method of FIGS. 9A and 9B. Alternatively, the smart SSB beam selection 1702 may, for example, be performed as described with regard to any one or combination of FIGS. 1, 2, 3A, 3B, or 15 or as described anywhere else within the present disclosure. In an example, the smart SSB beam selection 1702 includes scanning for available SSB beams, followed by candidate selection and target selection. Scanning, candidate selection, and target selection may, for example, correspond to acts 112, 114, and 116 in FIGS. 1, 4, 7A, or 9A.

After selecting the target SSB beam, the UE 102 transmits a RACH preamble 118 at the RACH occasion associated with the target SSB beam. Such transmission may also be known as a Msg1 transmission.

At act 1710, the RAN node 104 maps the RACH occasion on which the RACH preamble is received to the target SSB beam using the known associations between SSB beams and RACH occasions. This allows the RAN node 104 to beam form on the target SSB beam or on another SSB beam selected based on the target SSB beam.

The RAN node 104 transmits a RACH response 1712 in response to receipt of the RACH preamble 118. The RACH response 1712 may, for example, be transmitted on the target SSB beam or on another SSB beam. In the example of FIG. 17, it's assumed that the RAN node 104 received the RACH preamble 118. However, if not, the RACH preamble 118 may be retransmitted using an SSB beam with the greatest signal strength.

After the smart SSB beam selection 1702, the UE 102 performs a Physical Uplink Shared Channel (PUSCH) transmission 1714. Further, the RAN node 104 transmits a contention resolution message 1716 in response to the PUSCH transmission 1714. The PUSCH transmission 1714 may also be known as a Msg3 transmission, and the contention resolution message 1716 may also be known as a Msg4 transmission.

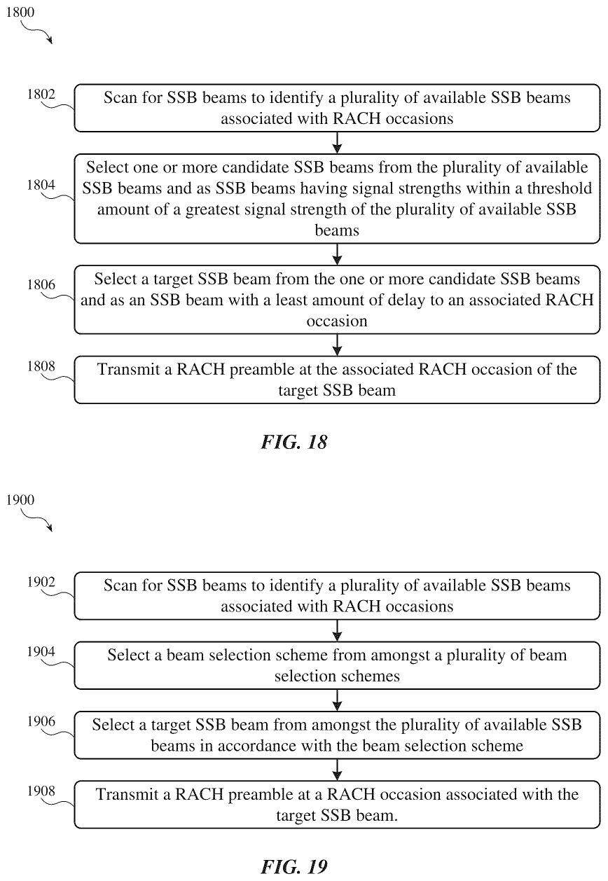

FIGS. 18 and 19 illustrate flow diagrams of example methods 1800, 1900 for smart SSB beam selection at a UE. The UE may, for example, correspond to the UE 102 of FIG. 1 or 17 or any other UE described throughout the present disclosure. Further, any one or combination of the methods 1800, 1900 may, for example, be performed during the smart SSB beam selection 1702 of FIG. 17.

Focusing on the method 1800 of FIG. 18, SSB beams are scanned for at act 1802 to identify a plurality of available SSB beams associated with RACH occasions. At act 1804, one or more candidate SSB beams are selected from the plurality of available SSB beams and as SSB beams having signal strengths within a threshold amount of a greatest signal strength of the plurality of available SSB beams. At act 1806, a target SSB beam is selected from the one or more candidate SSB beams and as an SSB beam with a least amount of delay to an associated RACH occasion. At act 1808, a RACH preamble is transmitted at the associated RACH occasion of the target SSB beam.

Focusing on the method 1900 of FIG. 19, SSB beams are scanned for at act 1902 to identify a plurality of available SSB beams associated with RACH occasions. At act 1904, a beam selection scheme is selected from amongst a plurality of beam selection schemes. The plurality of beam selection schemes may, for example, include the primary beam selection scheme 604 of FIG. 7A or 9A and the secondary beam selection scheme 606 of FIG. 7B or 9B. At act 1906, a target SSB beam is selected from amongst the plurality of available SSB beams in accordance with the beam selection scheme. At act 1908, a RACH preamble is transmitted at a RACH occasion associated with the target SSB beam.

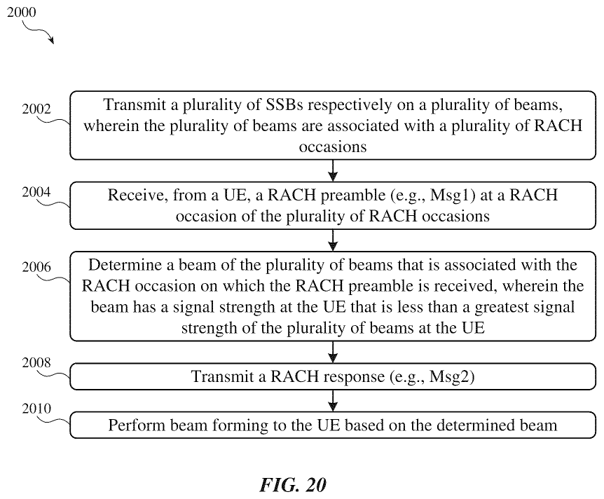

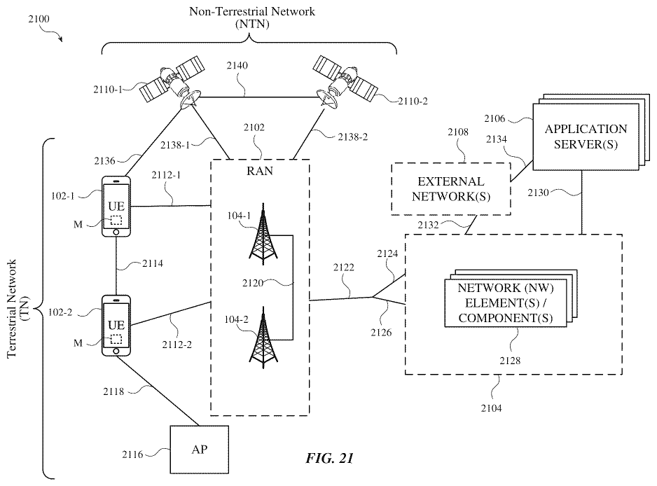

FIG. 20 illustrates a flow diagram of an example method 2000 for smart SSB beam selection at a RAN node. The RAN node may, for example, correspond to the RAN node 104 of FIG. 1 or 17 or any other RAN node described throughout the present disclosure.

At act 2002, a plurality of SSBs are transmitted respectively on a plurality of beams, wherein the plurality of beams are associated with a plurality of RACH occasions. At act 2004, a RACH preamble (e.g., Msg1) is received from a UE and at a RACH occasion of the plurality of RACH occasions. At act 2006, a beam of the plurality of beams that is associated with the RACH occasion on which the RACH preamble is received is determined, wherein the beam has a signal strength at the UE that is less than a greatest signal strength of the plurality of beams at the UE. At act 2008, a RACH response (e.g., Msg2) is transmitted. At act 2010, beam forming to the UE is performed based on the determined beam.

FIG. 21 illustrates a diagram of an example of a wireless communication network 2100 with smart SSB beam selection. Network 2100 may include one or more UEs 102-1, 102-2, etc. (referred to collectively as “UEs 102” and individually as “UE 102”), one or more RAN nodes 104-1, 104-2, etc. (referred to collectively as “RAN nodes 104” and individually as “RAN node 104”), a radio access network (RAN) 2102 formed by RAN nodes 104, a core network (CN) 2104, application servers 2106, external networks 2108, and one or more satellites 2110-1, 2110-2, etc. (referred to collectively as “satellites 2110” and individually as “satellite 2110”). Any one or combination of the foregoing may alternatively be omitted.

The systems and devices of example network 2100 may operate in accordance with one or more communication standards, such as 2nd generation (2G), 3rd generation (3G), 4G (e.g., LTE), and/or 5G (e.g., NR) communication standards of the 3GPP. Additionally, or alternatively, one or more of the systems and devices of network 2100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

UEs 102 refer to terminal devices including mobile or non-mobile computing devices connectable to one or more wireless communication networks and capable of wireless communications. Examples of such UEs may include internet of things (IoT) devices, handheld sets, laptop computers, desktop computers, etc., and could be installed on isolated or moving platforms such as factories, aircrafts, ships, oil platforms, and trains. A UE may support various wireless communication schemes and may utilize one or more types of technologies optimized for different use cases.

UEs 102 perform the various methods for smart SSB beam selection described throughout the present disclosure. For example, UEs 102 may perform the method for smart SSB beam selection in FIG. 4, FIGS. 7A and 7B, or FIGS. 9A and 9B during a contention-based RACH procedure. Performance of smart SSB beam selection by UEs 102 may be facilitated by beam-selection modules M that are individual to UEs 102. In an example, the beam-selection modules M are or include electronic circuitry and/or electronic processors that perform smart SSB beam selection. In another example, the beam-selection modules M are or include electronic memory storing processor executable instructions that, when executed by processors of UEs 102, perform smart SSB beam selection.

UEs 102 may communicate and establish a connection with (e.g., be communicatively coupled) with RAN 2102, which may involve one or more wireless channels 2112-1 and 2112-2 that each comprise a physical communications interface and/or layer. In some implementations, a UE 102 may be configured with dual connectivity (DC) as a multi-radio access technology (multi-RAT) or multi-radio dual connectivity (MR-DC). For example, a multiple receive and transmit (Rx/Tx) capable UE may use resources provided by different network nodes (e.g., RAN node 104-1 and RAN node 104-2) that may be connected via a non-ideal backhaul (e.g., where one RAN node provides NR access and the other RAN node provides either E-UTRA for LTE or NR access for 5G). UEs 102 may additionally communicate directly via a Side Link (SL) wireless interface 2114 and/or may connect to access point (AP) 2116 via wireless interface 2118. AP 2116 may comprise a wireless local area network (WLAN), WLAN node, WLAN termination point, etc.

RAN 2102 may include RAN nodes 104, which may also be referred to as base stations. RAN nodes 104 enable wireless channels 2112-1 and 2112-2 to be established between UEs 102 and RAN 2102. RAN nodes 104 may include network access points configured to provide radio baseband functions for data and/or voice connectivity between users and the network based on one or more of the communication technologies described herein (e.g., 2G, 3G, 4G, 5G, WiFi, etc.). As examples, a RAN node may be an LTE base station (e.g., an E-UTRAN Node B, an enhanced Node B, an eNodeB, an eNB, a 4G base station, etc.), a next generation base station (e.g., a next generation Node B, a gNodeB, a gNB, a 5G base station, NR base station, etc.), and the like.

RAN nodes 104 may include a roadside unit (RSU), a transmission reception point (TRxP or TRP), and one or more other types of ground stations (e.g., terrestrial access points). In some scenarios, RAN nodes 104 may be a dedicated physical device, such as a macrocell base station, and/or a low power (LP) base station for providing femtocells, picocells, or other like having smaller coverage areas, smaller user capacities, or higher bandwidth compared to macrocells. As described below, in some implementations, satellites 2110 may operate as RAN nodes (e.g., RAN nodes 104) with respect to UEs 102. As such, references herein to a RAN node, RAN node 104, etc., may involve implementations where the RAN node, RAN node 104, etc., is a terrestrial network node and also to implementations where the RAN node, RAN node 104, etc., is a non-terrestrial network node.

RAN nodes 104 may be configured to communicate with one another via interface 2120 and with CN 2104 via interface 2122. In implementations where the system is an LTE system, interface 2120 may be an X2 interface and interface 2122 may be an S1 interface. 5G may operate in two modes, including a non-standalone mode and a standalone mode. For non-standalone operation, interface 2120 and interface 2122 may respectively be the X2 and S1 interfaces. For standalone operation, interface 2120 and interface 2122 may respectively be an Xn interface and a Next Generation (NG) interface. Supposing interface 2122 is the NG interface, interface 2122 may be split into two parts: a NG user plane (NG-U) interface 2124; and an NG control plane (NG-C) interface 2126.

CN 2104 may comprise a plurality of network elements 2128, which are configured to offer various data and telecommunications services to customers and/or subscribers (e.g., users of UEs 102) who are connected to the CN 2104 via the RAN 2102. In some implementations, CN 2104 may include an evolved packet core (EPC), a 5G CN, and/or one or more additional or alternative types of CNs. The components of the CN 2104 may be implemented in one physical node or separate physical nodes including components to read and execute instructions from a machine-readable or computer-readable medium (e.g., a non-transitory machine-readable storage medium).

CN 2104, application servers 2106, and external networks 2108 may be connected to one another via interfaces 2130, 2132, and 2134, which may include IP network interfaces. Application servers 2106 may include one or more server devices or network elements (e.g., virtual network functions (VNFs)) offering applications that use IP bearer resources with CN 2104 (e.g., universal mobile telecommunications system packet services (UMTS PS) domain, LTE PS data services, etc.). Application server 2106 may also, or alternatively, be configured to support one or more communication services (e.g., voice over IP (VoIP) sessions, push-to-talk (PTT) sessions, group communication sessions, social networking services, etc.) for UEs 102 via the CN 2104. External networks 2108 may include one or more of a variety of networks, including the Internet, thereby providing the network and UEs 102 of the network access to a variety of additional services, information, interconnectivity, and so on.

Satellites 2110 may be in communication with UEs 102 via service link or wireless interface 2136 and/or RAN 2102 via wireless interfaces 2138 (depicted individually as 2138-1 and 2138-2). In some implementations, satellite 2110 may operate as a passive or transparent network relay node regarding communications between UE 102 and the terrestrial network (e.g., RAN 2102). In some implementations, satellite 2110 may operate as an active or regenerative network node such that satellite 2110 may operate as RAN nodes 104 (e.g., as a gNB of RAN 2102) regarding communications between UE 102 and RAN 2102. In some implementations, satellites 2110 may communicate with one another via a direct wireless interface 2140 or an indirect wireless interface (e.g., via RAN 2102 using wireless interfaces 2138-1 and 2138-2). Satellite 2110 may include a geostationary (GEO) satellite, a Low Earth Orbit (LEO) satellite, or another type of satellite.

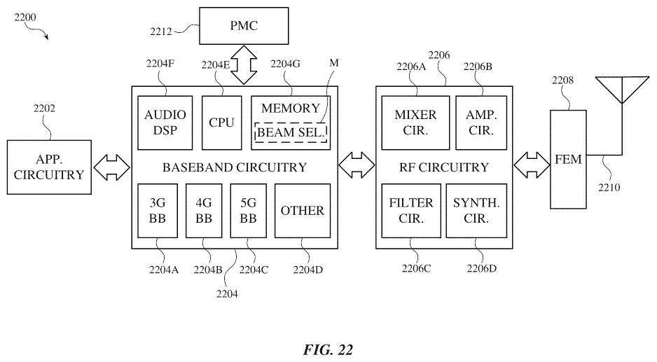

FIG. 22 illustrates a diagram of an example of a device 2200 within a wireless communication network with smart SSB beam selection. The device 2200 may be a UE or a RAN node, such as UEs 102 (e.g., 102-1, 102-2, etc.) or RAN nodes 104 (e.g., 104-1, 104-2, etc.). Further, to the extent that the device 2200 is a UE, the device may perform the various methods for smart SSB beam selection described throughout the present disclosure. For example, UEs 102 may perform the method for smart SSB beam selection in FIG. 4, FIGS. 7A and 7B, or FIGS. 9A and 9B during a contention-based RACH procedure.

In some implementations, the device 2200 can include application circuitry 2202, baseband circuitry 2204, RF circuitry 2206, front-end module (FEM) circuitry 2208, one or more antennas 2210, and power management circuitry (PMC) 2212 coupled together at least as shown. In some implementations, the device 2200 can include fewer elements (e.g., a RAN node may not utilize application circuitry 2202, and may instead include a processor/controller to process IP data received from a CN). In some implementations, the device 2200 may include additional elements such as, for example, memory/storage, a display, a camera, one or more sensors (e.g., one or more temperature sensors), or an input/output (I/O) interface. In other implementations, the elements described below can be included in more than one device (e.g., said circuitries can be separately included in more than one device for Cloud-RAN (C-RAN) implementations or the like).

The application circuitry 2202 can include one or more application processors. For example, the application circuitry 2202 can include circuitry, such as, but not limited to, one or more single-core or multi-core processors. The processor(s) can include any combination of general-purpose processors and dedicated processors (e.g., graphics processors, application processors, etc.). The processor(s) can be coupled with or include memory/storage and can be configured to execute instructions stored in the memory/storage to enable various applications or operating systems to run on the device 2200. In some implementations, processor(s) of application circuitry 2202 can process IP data packets received from an CN.

The baseband circuitry 2204 can include circuitry, such as, but not limited to, one or more single-core or multi-core processors. The baseband circuitry 2204 can include one or more baseband processors or control logic to process baseband signals received from a receive signal path of the RF circuitry 2206 and to generate baseband signals for a transmit signal path of the RF circuitry 2206. Baseband circuitry 2204 can interface with the application circuitry 2202 for generation and processing of the baseband signals and for controlling operations of the RF circuitry 2206.

In some implementations, the baseband circuitry 2204 includes a 3G baseband processor 2204A, a 4G baseband processor 2204B, a 5G baseband processor 2204C, or other baseband processor(s) 2204D for other existing generations or generations in development or to be developed (e.g., 2G, 6G, etc.). The baseband circuitry 2204 (e.g., one or more of baseband processors 2204A-2204D) can handle various radio control functions that enable communication with one or more radio networks via the RF circuitry 2206. In other implementations, some or all of the functionality of baseband processors 2204A-2204D can be included in modules stored in a memory 2204G and executed via a Central Processing Unit (CPU) 2204E. In an example, and to the extent that the device 2200 is a UE, the memory 2204G may include a beam-selection module M. The beam-selection module M may correspond to processor executable instructions that, when executed by the CPU 2204E, cause the device 2200 to perform any method for smart SSB beam selection described throughout the present disclosure. Further, the beam-selection module M may be omitted when the device is a RAN node or some device type other than a UE.

The radio control functions can include, but are not limited to, signal modulation/demodulation, encoding/decoding, radio frequency shifting, etc. In some implementations, modulation/demodulation circuitry of the baseband circuitry 2204 can include Fast-Fourier Transform (FFT), precoding, or constellation mapping/de-mapping functionality. In some implementations, encoding/decoding circuitry of the baseband circuitry 2204 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 2204 can include one or more audio digital signal processor(s) (DSP) 2204F. The audio DSPs 2204F can include elements for compression/decompression and echo cancellation and can include other suitable processing elements in other implementations. Components of the baseband circuitry 2204 can be suitably combined in a single chip, a single chipset, or disposed on a same circuit board in some implementations. In some implementations, some or all of the constituent components of the baseband circuitry 2204 and the application circuitry 2202 can be implemented together such as, for example, on a system on a chip (SoC).

In some implementations, the baseband circuitry 2204 can provide for communication compatible with one or more radio technologies. For example, in some implementations, the baseband circuitry 2204 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 2204 is configured to support radio communications of more than one wireless protocol can be referred to as multi-mode baseband circuitry.

RF circuitry 2206 can enable communication with wireless networks using modulated electromagnetic radiation through a non-solid medium. In various implementations, the RF circuitry 2206 can include switches, filters, amplifiers, etc. to facilitate the communication with the wireless network. RF circuitry 2206 can include a receive signal path which can include circuitry to down-convert RF signals received from the FEM circuitry 2208 and provide baseband signals to the baseband circuitry 2204. RF circuitry 2206 can also include a transmit signal path which can include circuitry to up-convert baseband signals provided by the baseband circuitry 2204 and provide RF output signals to the FEM circuitry 2208 for transmission.

In some implementations, the receive signal path of the RF circuitry 2206 can include mixer circuitry 2206A, amplifier circuitry 2206B, and filter circuitry 2206C. In some implementations, the transmit signal path of the RF circuitry 2206 can include filter circuitry 2206C and mixer circuitry 2206A. RF circuitry 2206 can also include synthesizer circuitry 2206D for synthesizing a frequency for use by the mixer circuitry 2206A of the receive signal path and the transmit signal path.

In some implementations, the mixer circuitry 2206A of the receive signal path can be configured to down-convert RF signals received from the FEM circuitry 2208 based on the synthesized frequency provided by synthesizer circuitry 2206D. The amplifier circuitry 2206B can be configured to amplify the down-converted signals and the filter circuitry 2206C can be a low-pass filter (LPF) or band-pass filter (BPF) configured to remove unwanted signals from the down-converted signals to generate output baseband signals. Output baseband signals can be provided to the baseband circuitry 2204 for further processing. In some implementations, the output baseband signals can be zero-frequency baseband signals, although this is not a requirement. In some implementations, mixer circuitry 2206A of the receive signal path can comprise passive mixers, although the scope of the implementations is not limited in this respect.

In some implementations, the mixer circuitry 2206A of the transmit signal path can be configured to up-convert input baseband signals based on the synthesized frequency provided by the synthesizer circuitry 2206D to generate RF output signals for the FEM circuitry 2208. The baseband signals can be provided by the baseband circuitry 2204 and can be filtered by filter circuitry 2206C.

In some implementations, the mixer circuitry 2206A of the receive signal path and the mixer circuitry 2206A of the transmit signal path can include two or more mixers and can be arranged for quadrature down conversion and up conversion, respectively. In some implementations, the mixer circuitry 2206A of the receive signal path and the mixer circuitry 2206A of the transmit signal path can include two or more mixers and can be arranged for image rejection (e.g., Hartley image rejection). In some implementations, the mixer circuitry 2206A of the receive signal path and the mixer circuitry 2206A of the transmit signal path can be arranged for direct down conversion and direct up conversion, respectively. In some implementations, the mixer circuitry 2206A of the receive signal path and the mixer circuitry 2206A of the transmit signal path can be configured for super-heterodyne operation.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 2206 can include analog-to-digital converter (ADC) and digital-to-analog converter (DAC) circuitry and the baseband circuitry 2204 can include a digital baseband interface to communicate with the RF circuitry 2206. In some dual-mode implementations, a separate radio IC circuitry can be provided for processing signals for each spectrum, although the scope of the implementations is not limited in this respect.

In some implementations, the synthesizer circuitry 2206D can be a fractional-N synthesizer or a fractional N/N+1 synthesizer, although the scope of the implementations is not limited in this respect as other types of frequency synthesizers can be suitable. For example, synthesizer circuitry 2206D can be a delta-sigma synthesizer, a frequency multiplier, or a synthesizer comprising a phase-locked loop with a frequency divider.

The synthesizer circuitry 2206D can be configured to synthesize an output frequency for use by the mixer circuitry 2206A of the RF circuitry 2206 based on a frequency input and a divider control input. In some implementations, frequency input can be provided by a voltage-controlled oscillator (VCO), although that is not a requirement. Further, in some implementations, divider control input can be provided by either the baseband circuitry 2204 or the applications circuitry 2202 depending on the desired output frequency. In some implementations, a divider control input (e.g., N) can be determined from a look-up table based on a channel indicated by the applications circuitry 2202.

Synthesizer circuitry 2206D can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 2206D can be configured to generate a carrier frequency as the output frequency. In other implementations, the output frequency can be a multiple of the carrier frequency (e.g., twice the carrier frequency, four times the carrier frequency, etc.) and used in conjunction with quadrature generator and divider circuitry to generate multiple signals at the carrier frequency with multiple different phases with respect to each other. In some implementations, the output frequency can be a LO frequency (fLO) and/or the RF circuitry 2206 can include an IQ/polar converter.

FEM circuitry 2208 can include a receive signal path, which can include circuitry configured to operate on RF signals received from one or more antennas 2210, amplify the received signals, and provide the amplified versions of the received signals to the RF circuitry 2206 for further processing. FEM circuitry 2208 can also include a transmit signal path which can include circuitry configured to amplify signals for transmission provided by the RF circuitry 2206 for transmission by one or more of the one or more antennas 2210. In various implementations, the amplification through the transmit or receive signal paths can be done solely in the RF circuitry 2206, solely in the FEM circuitry 2208, or in both the RF circuitry 2206 and the FEM circuitry 2208.

In some implementations, the FEM circuitry 2208 can include a TX/RX switch to switch between transmit mode and receive mode operation. The FEM circuitry 2208 can include a receive signal path and a transmit signal path. The receive signal path of the FEM circuitry 2208 can include a Low Noise Amplifier (LNA) to amplify received RF signals and provide the amplified received RF signals as an output (e.g., to the RF circuitry 2206). The transmit signal path of the FEM circuitry 2208 can include a power amplifier (PA) to amplify input RF signals (e.g., provided by RF circuitry 2206), and one or more filters to generate RF signals for subsequent transmission (e.g., by one or more of the one or more antennas 2210).

In some implementations, the PMC 2212 can manage power provided to the baseband circuitry 2204. In particular, the PMC 2212 can control power-source selection, voltage scaling, battery charging, or direct current (DC)-to-DC conversion. The PMC 2212 can be included when the device 2200 is capable of being powered by a battery (e.g., when the device 2200 is a UE). The PMC 2212 can increase the power conversion efficiency while providing desirable implementation size and heat dissipation characteristics.

While FIG. 22 shows the PMC 2212 coupled only with the baseband circuitry 2204, the PMC 2212 may be additionally or alternatively be coupled with, and perform similar power management operations for, other components such as, but not limited to, application circuitry 2202, RF circuitry 2206, or FEM circuitry 2208.

In some implementations, the PMC 2212 can control, or otherwise be part of, various power saving mechanisms of the device 2200. For example, if the device 2200 is in an RRC_Connected state, where it is still connected to the RAN node 104 as it expects to receive traffic shortly, then it can enter a state known as Discontinuous Reception Mode (DRX) after a period of inactivity. During this state, the device 2200 can power down for brief intervals of time and thus save power.

If there is no data traffic activity for an extended period of time, then the device 2200 can transition off to an RRC_Idle state, where it disconnects from the network and does not perform operations such as channel quality feedback, handover, etc. The device 2200 goes into a very low power state and it performs paging where again it periodically wakes up to listen to the network and then powers down again. The device 2200 may not receive data in this state; to receive data, it can transition back to RRC_Connected state. An additional power saving mode can allow a device to be unavailable to the network for periods longer than a paging interval (e.g., ranging from seconds to a few hours). During this time, the device is totally unreachable to the network and can power down completely. Any data sent during this time incurs a large delay and it is assumed the delay is acceptable.

Processors of the application circuitry 2202 and processors of the baseband circuitry 2204 can be used to execute elements of one or more instances of a protocol stack. For example, processors of the baseband circuitry 2204, alone or in combination, can be used execute Layer 3, Layer 2, or Layer 1 functionality, while processors of the baseband circuitry 2204 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

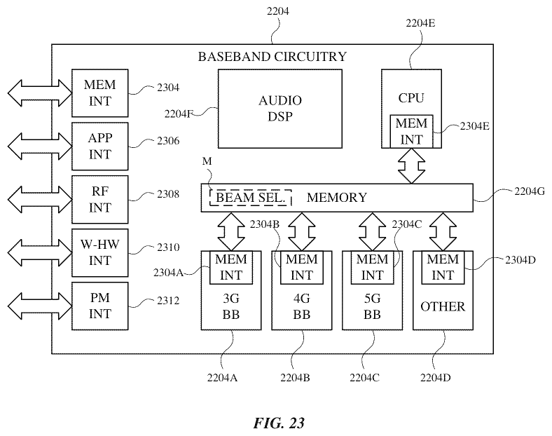

FIG. 23 illustrates a diagram of an example of the baseband circuitry 2204 of FIG. 22. The baseband circuitry 2204 comprises processors 2204A-2204E and a memory 2204G utilized by said processors. Each of the processors 2204A-2204E includes a memory interface 2302A-2302E, respectively, to send/receive data to/from the memory 2204G.

The baseband circuitry 2204 can further include one or more interfaces to communicatively couple to other circuitries/devices. Such one or more interface may include a memory interface 2304 (e.g., an interface to send/receive data to/from memory external to the baseband circuitry 2204), an application circuitry interface 2306 (e.g., an interface to send/receive data to/from the application circuitry 2202 of FIG. 22), an RF circuitry interface 2308 (e.g., an interface to send/receive data to/from RF circuitry 2206 of FIG. 22), a wireless hardware connectivity interface 2310 (e.g., an interface to send/receive data to/from other communication components), and a power management interface 2312 (e.g., an interface to send/receive power or control signals to/from the PMC 2212).

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a baseband circuitry is provided, comprising: one or more memories configured to store instructions; and one or more processors coupled to the one or more memories and, when executing the instructions from the one or more memories, configured to: scan for SSB beams to identify a plurality of available SSB beams associated with RACH occasions; select one or more candidate SSB beams from the plurality of available SSB; select a target SSB beam from the one or more candidate SSB beams and as an SSB beam with a least amount of delay to an associated RACH occasion; and output a RACH preamble for transmission at the associated RACH occasion of the target SSB beam.

Example 2 includes the subject matter of example 1, including or omitting optional elements, wherein the one or more candidate SSB beams are selected as SSB beams having signal strengths within a threshold amount of a greatest signal strength of the plurality of available SSB beams.

Example 3 includes the subject matter of any one or more of examples 1 and 2, including or omitting optional elements, wherein the one or more candidate SSB beams include a plurality of candidate SSB beams and have a total number of SSB beams that is less than a total number of SSB beams of the plurality of available SSBs.

Example 4 includes the subject matter of any one or more of examples 1-3, including or omitting optional elements, wherein the target SSB beam is different than an SSB beam of the plurality of available SSB beams having a greatest signal strength.

Example 5 includes the subject matter of example 4, including or omitting optional elements, wherein the one or more processors are further configured to, in response to transmit failure of the RACH preamble, output the RACH preamble for retransmission at a RACH occasion associated with the SSB beam of the plurality of available SSB beams having the greatest signal strength.

Example 6 includes the subject matter of any one or more of examples 1-5, including or omitting optional elements, wherein the one or more candidate SSB beams include a plurality of candidate SSB beams sharing a greatest signal strength of the plurality of available SSB beams.

Example 7 includes the subject matter of any one or more of examples 1-6, including or omitting optional elements, wherein the one or more processors are further configured to perform a contention-based RACH process, which comprises the output of the RACH preamble for transmission.

Example 8 includes the subject matter of any one or more of examples 1-7, including or omitting optional elements, wherein the one or more processors are further configured to vary the threshold amount over time for future RACH-preamble transmissions.

Example 9 includes the subject matter of any one or more of examples 1-8, including or omitting optional elements, wherein selection of the one or more candidate SSB beams and selection of the target SSB beam form a first beam selection scheme, wherein the one or more processors are further configured to: select a next target SSB beam from the plurality of available SSB beams according to a second beam selection scheme; and output the RACH preamble for transmission at a RACH occasion associated with the next target SSB beam.

In example 10, which may also include one or more of the examples described herein, a UE is provided, comprising: RF circuitry; a memory; and one or more processors configured to, when executing instructions stored in the memory, cause the UE to: scan, via the RF circuitry, for SSB beams to identify a plurality of available SSB beams; select one or more candidate SSB beams from the plurality of available SSB beams and as SSB beams having signal strengths within a threshold amount of a greatest signal strength of the plurality of available SSB beams; select a target SSB beam from the one or more candidate SSB beams; and transmit, via the RF circuitry, a RACH preamble at an associated RACH occasion of the target SSB beam.

Example 11 includes the subject matter of example 10, including or omitting optional elements, wherein the target SSB beam is selected based on individual delays that the one or more candidate SSB beams have to associated RACH occasions.

Example 12 includes the subject matter of any one or more of examples 10 and 11, including or omitting optional elements, wherein the one or more processors are further configured to: set the threshold amount to zero in response to a calculated RACH power being above a maximum transmit power limit; and set the threshold amount to a non-zero value in response to the calculated RACH power being below the maximum transmit power limit.

Example 13 includes the subject matter of any one or more of examples 10 and 11, including or omitting optional elements, wherein the one or more processors are further configured to: set the threshold amount to a first value in response to the greatest signal strength of the plurality of available SSB beams falling within a first range; and set the threshold amount to a second value less than the first value in response to the greatest signal strength falling within a second range less than the first range.

Example 14 includes the subject matter of any one or more of examples 10 and 11, including or omitting optional elements, wherein the one or more processors are further configured to: set the threshold amount to a first value in response to a difference between a calculated RACH power and a maximum transmit power limit falling within a first range; and set the threshold amount to a second value less than the first value in response to the difference falling within a second range less than the first range.

Example 15 includes the subject matter of any one or more of examples 10 and 11, including or omitting optional elements, wherein the one or more processors are further configured to set the threshold amount based on historical data regarding a failure rate of previous RACH-preamble transmissions.

Example 16 includes the subject matter of example 15, including or omitting optional elements, wherein the one or more processors are further configured to: decrease the threshold amount in response to the failure rate of the previous RACH-preamble transmissions being above a threshold; and increase the threshold amount in response to the failure rate of the previous RACH-preamble transmissions being below the threshold.

Example 17 includes the subject matter of any one or more of examples 10-16, including or omitting optional elements, wherein the one or more processors are further configured to, in response to failed transmission of the RACH preamble restrict the threshold amount to zero for future RACH-preamble transmissions for a predetermined amount of time.

In example 18, which may also include one or more of the examples described herein, a method is provided, comprising: scanning for SSB beams to identify a plurality of available SSB beams associated with RACH occasions; selecting a beam selection scheme from amongst a plurality of beam selection schemes; selecting a target SSB beam from amongst the plurality of available SSB beams in accordance with the beam selection scheme; and transmitting a RACH preamble at a RACH occasion associated with the target SSB beam.

Example 19 includes the subject matter of example 18, including or omitting optional elements, wherein the beam selection scheme comprises: selecting one or more candidate SSB beams from the plurality of available SSB beams and as SSB beams having probabilities of RACH success within a threshold amount of a greatest probability of RACH success of the plurality of available SSB beams; and selecting the target SSB beam from the one or more candidate SSB beams and as an SSB beam with a least amount of delay to an associated RACH occasion.

Example 20 includes the subject matter of any one or more of examples 18 and 19, including or omitting optional elements, wherein the selecting of the beam selection scheme comprises: selecting a first beam selection scheme of the plurality of beam selection schemes in response to a calculated RACH power being below a maximum transmit power limit; and selecting a second beam selection scheme of the plurality of beam selection schemes in response to the calculated RACH power being above the maximum transmit power limit.

Example 21 includes the subject matter of example 20, including or omitting optional elements, wherein the first beam selection scheme generates a group of candidate SSB beams from the plurality of available SSB beams and selects the target SSB beam from the group of candidate SSB beams, and wherein the second beam selection scheme does not generate the group of candidate SSB beams.

Example 22 includes the subject matter of any one or more of examples 18-20, including or omitting optional elements, wherein the beam selection scheme corresponds to a first beam selection scheme of the plurality of beam selection schemes, and wherein the method further comprises: in response to failure of the transmitting, suspending use of the first beam selection scheme for future RACH-preamble transmission for a predetermined amount of time.

In example 23, which may also include one or more of the examples described herein, a baseband circuitry is provided, comprising: one or more memories configured to store instructions; and one or more processors coupled to the one or more memories and, when executing the instructions from the one or more memories, configured to: receive a plurality of SSBs of an SSB burst respectively via a plurality of SSB beams, wherein each of the plurality of SSBs is associated with a RACH occasion; select one or more candidate SSBs from the plurality of SSBs and as SSBs having signal strengths within a threshold amount of a greatest signal strength of the plurality of SSBs; select a target SSB from the one or more candidate SSBs and as an SSB with a least amount of delay to an associated RACH occasion; and output a RACH preamble for transmission at the associated RACH occasion of the target SSB.

Example 24 includes the subject matter of example 23, including or omitting optional elements, wherein the one or more candidates SSBs include a plurality of candidate SSBs and have a total number of SSBs that is less than a total number of SSBs of the plurality of SSBs.

Example 25 includes the subject matter of any one or more of examples 23 and 24, including or omitting optional elements, wherein the target SSB has a signal strength other than the greatest signal strength.

Example 26 includes the subject matter of example 25, including or omitting optional elements, wherein the one or more processors are further configured to, in response to transmit failure of the RACH preamble, output the RACH preamble for retransmission at a RACH occasion associated with an SSB of the plurality of SSBs, which has the greatest signal strength.

Example 27 includes the subject matter of any one or more of examples 23-26, including or omitting optional elements, wherein the one or more candidate SSBs include a plurality of candidate SSBs, each having the greatest signal strength.

Example 28 includes the subject matter of any one or more of examples 23-27, including or omitting optional elements, wherein the one or more processors are further configured to perform a contention-based RACH process, which comprises the output of the RACH preamble for transmission.

Example 29 includes the subject matter of any one or more of examples 23-28, including or omitting optional elements, wherein the one or more processors are further configured to: set the threshold amount to zero in response to a calculated RACH power being above a maximum transmit power limit; and set the threshold amount to a non-zero value in response to the calculated RACH power being below the maximum transmit power limit.

Example 30 includes the subject matter of any one or more of examples 23-28, including or omitting optional elements, wherein the one or more processors are further configured to: set the threshold amount to a first value in response to the greatest signal strength falling within a first range; and set the threshold amount to a second value less than the first value in response to the greatest signal strength falling within a second range less than the first range.

Example 31 includes the subject matter of any one or more of examples 23-28, including or omitting optional elements, wherein the one or more processors are further configured to: set the threshold amount to a first value in response to a difference between a calculated RACH power and a maximum transmit power limit falling within a first range; and set the threshold amount to a second value less than the first value in response to the difference falling within a second range less than the first range.

Example 32 includes the subject matter of any one or more of examples 23-28, including or omitting optional elements, wherein the one or more processors are further configured to set the threshold amount based on historical data regarding a failure rate of previous RACH-preamble transmissions.

Example 33 includes the subject matter of example 32, including or omitting optional elements, wherein the one or more processors are further configured to: decrease the threshold amount in response to the failure rate of the previous RACH-preamble transmissions being above a threshold; and increase the threshold amount in response to the failure rate of the previous RACH-preamble transmissions being below the threshold.

Example 34 includes the subject matter of any one or more of examples 23-33, including or omitting optional elements, wherein the one or more processors are further configured to, in response to failed transmission of the RACH preamble, restrict the threshold amount to zero for future RACH-preamble transmissions for a predetermined amount of time.

Example 35 includes the subject matter of any one or more of examples 23-34, wherein the one or more processors are further configured to vary the threshold amount over time for future RACH-preamble transmissions.

Example 36 includes the subject matter of any one or more of examples 23-35, wherein selection of the one or more candidate SSBs and selection of the target SSB form a first beam selection scheme, wherein the one or more processors are further configured to: select a next target SSB from the plurality of SSBs according to a second beam selection scheme; and output the RACH preamble for transmission at a RACH occasion associated with the next target SSB beam.

Example 37 is an apparatus that includes means for performing the functions performed by the one or more processors in any one or more of examples 1-17 and 23-36 or the functions performed by the method in any one or more of examples 18-22.

Example 38 is a processor or device (e.g., UE) that is configured to perform the functions performed by the one or more processors in any one or more of examples 1-17 and 23-36 or the functions performed by the method in any one or more of examples 18-22.

Example 39 is a method that performs the functions performed by the one or more processors in any one or more of examples 1-17 and 23-36.

Example 40 is a non-volatile computer-readable medium that stores instructions that, when executed by one or more processors, cause the performance of the functions performed by the one or more processors in any one or more of examples 1-17 and 23-36 or the functions performed by the method in any one or more of examples 18-22.

Example 41 is a method that includes any action or combination of actions as substantially described herein in the Detailed Description.

Example 42 is a method as substantially described herein with reference to each or any combination of the Figures included herein or with reference to each or any combination of paragraphs in the Detailed Description.

Example 43 is a UE configured to perform any action or combination of actions as substantially described herein in the Detailed Description as included in the UE.

Example 44 is a network node configured to perform any action or combination of actions as substantially described herein in the Detailed Description as included in the network node.

Example 45 is a non-volatile computer-readable medium that stores instructions that, when executed, cause the performance of any action or combination of actions as substantially described herein in the Detailed Description.

Example 46 is a baseband circuitry or processor of a UE configured to perform any action or combination of actions as substantially described herein in the Detailed Description as included in the UE.

Example 47 is a baseband circuitry or processor of a network node configured to perform any action or combination of actions as substantially described herein in the Detailed Description as included in the network node.

Other examples may include a method (e.g., a process) and/or a computer-readable medium implementation of any of the foregoing examples or combinations thereof. The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given, or particular, application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A baseband circuitry, comprising:
one or more memories configured to store instructions; and
one or more processors coupled to the one or more memories and, when executing the instructions from the one or more memories, configured to:
scan for Synchronization Signal Block (SSB) beams to identify a plurality of available SSB beams associated with Random Access Channel (RACH) occasions;
select one or more candidate SSB beams from the plurality of available SSB;
select a target SSB beam from the one or more candidate SSB beams and as an SSB beam with a least amount of delay to an associated RACH occasion; and
output a RACH preamble for transmission at the associated RACH occasion of the target SSB beam.

2. The baseband circuitry according to claim 1, wherein the one or more candidate SSB beams are selected as SSB beams having signal strengths within a threshold amount of a greatest signal strength of the plurality of available SSB beams.

3. The baseband circuitry according to claim 1, wherein the one or more candidate SSB beams include a plurality of candidate SSB beams and have a total number of SSB beams that is less than a total number of SSB beams of the plurality of available SSBs.

4. The baseband circuitry according to claim 1, wherein the target SSB beam is different than an SSB beam of the plurality of available SSB beams having a greatest signal strength.

5. The baseband circuitry according to claim 4, wherein the one or more processors are further configured to:
in response to transmit failure of the RACH preamble, output the RACH preamble for retransmission at a RACH occasion associated with the SSB beam of the plurality of available SSB beams having the greatest signal strength.

6. The baseband circuitry according to claim 1, wherein the one or more candidate SSB beams include a plurality of candidate SSB beams sharing a greatest signal strength of the plurality of available SSB beams.

7. The baseband circuitry according to claim 1, wherein the one or more processors are further configured to:
perform a contention-based RACH process, which comprises the output of the RACH preamble for transmission.

8. A user equipment (UE), comprising:
radio frequency (RF) circuitry;
a memory; and
one or more processors configured to, when executing instructions stored in the memory, cause the UE to:
scan, via the RF circuitry, for Synchronization Signal Block (SSB) beams to identify a plurality of available SSB beams;
select one or more candidate SSB beams from the plurality of available SSB beams and as SSB beams having signal strengths within a threshold amount of a greatest signal strength of the plurality of available SSB beams;
select a target SSB beam from the one or more candidate SSB beams; and
transmit, via the RF circuitry, a RACH preamble at an associated Random Access Channel (RACH) occasion of the target SSB beam.

9. The UE according to claim 8, wherein the target SSB beam is selected based on individual delays that the one or more candidate SSB beams have to associated RACH occasions.

10. The UE according to claim 8, wherein the one or more processors are further configured to:
set the threshold amount to zero in response to a calculated RACH power being above a maximum transmit power limit; and
set the threshold amount to a non-zero value in response to the calculated RACH power being below the maximum transmit power limit.

11. The UE according to claim 8, wherein the one or more processors are further configured to:
set the threshold amount to a first value in response to the greatest signal strength of the plurality of available SSB beams falling within a first range; and
set the threshold amount to a second value less than the first value in response to the greatest signal strength falling within a second range less than the first range.

12. The UE according to claim 8, wherein the one or more processors are further configured to:
set the threshold amount to a first value in response to a difference between a calculated RACH power and a maximum transmit power limit falling within a first range; and
set the threshold amount to a second value less than the first value in response to the difference falling within a second range less than the first range.

13. The UE according to claim 8, wherein the one or more processors are further configured to:
set the threshold amount based on historical data regarding a failure rate of previous RACH-preamble transmissions.

14. The UE according to claim 13, wherein the one or more processors are further configured to:
decrease the threshold amount in response to the failure rate of the previous RACH-preamble transmissions being above a threshold; and
increase the threshold amount in response to the failure rate of the previous RACH-preamble transmissions being below the threshold.

15. The UE according to claim 8, wherein the one or more processors are further configured to, in response to failed transmission of the RACH preamble:
restrict the threshold amount to zero for future RACH-preamble transmissions for a predetermined amount of time.

16. A method, comprising:
scanning for Synchronization Signal Block (SSB) beams to identify a plurality of available SSB beams associated with Random Access Channel (RACH) occasions;
selecting a beam selection scheme from amongst a plurality of beam selection schemes;
selecting a target SSB beam from amongst the plurality of available SSB beams in accordance with the beam selection scheme; and
transmitting a RACH preamble at a RACH occasion associated with the target SSB beam.

17. The method according to claim 16, wherein the beam selection scheme comprises:
selecting one or more candidate SSB beams from the plurality of available SSB beams and as SSB beams having probabilities of RACH success within a threshold amount of a greatest probability of RACH success of the plurality of available SSB beams; and
selecting the target SSB beam from the one or more candidate SSB beams and as an SSB beam with a least amount of delay to an associated RACH occasion.

18. The method according to claim 16, wherein the selecting of the beam selection scheme comprises:
selecting a first beam selection scheme of the plurality of beam selection schemes in response to a calculated RACH power being below a maximum transmit power limit; and
selecting a second beam selection scheme of the plurality of beam selection schemes in response to the calculated RACH power being above the maximum transmit power limit.

19. The method according to claim 18, wherein the first beam selection scheme generates a group of candidate SSB beams from the plurality of available SSB beams and selects the target SSB beam from the group of candidate SSB beams, and wherein the second beam selection scheme does not generate the group of candidate SSB beams.

20. The method according to claim 16, wherein the beam selection scheme corresponds to a first beam selection scheme of the plurality of beam selection schemes, and wherein the method further comprises:
in response to failure of the transmitting, suspending use of the first beam selection scheme for future RACH-preamble transmission for a predetermined amount of time.
